(19) United States
(12) Patent Application Publication
(10) Pub. No.: US 2026/0067043 A1
(43) Pub. Date: Mar. 5, 2026

(54) PROCESSING METHOD, COMMUNICATION DEVICE AND STORAGE MEDIUM

(71) Applicant: Shanghai Transsion Co., Ltd., Shanghai (CN)

(72) Inventors: Tian LI, Shanghai (CN); Wei HUANG, Shanghai (CN)

(73) Assignee: Shanghai Transsion Co., Ltd., Shanghai (CN)

(21) Appl. No.: 19/385,069

(22) Filed: Nov. 10, 2025

Related U.S. Application Data
(63) Continuation of application No. PCT/CN2023/093655, filed on May 11, 2023.

(51) Int. Cl. H04L 5/00; H04B 7/06; H04B 17/318

(52) U.S. Cl. CPC H04L 5/0044; H04B 7/06952; H04B 17/328

(57) ABSTRACT

Disclosed are a processing method, a communication device and a storage medium, aiming to provide a method for determining the TCI state of the PUSCH. The processing method includes: determining the TCI state of the PUSCH based on downlink information. The method relates to the technical field of communication, can be applied to transmission in spatial division multiplexing and single frequency network scheme.

### CROSS-REFERENCE TO RELATED APPLICATIONS

This application is a continuation application of International Application No. PCT/CN2023/093655, filed on May 11, 2023, the entire contents of which are incorporated herein by reference.

### TECHNICAL FIELD

The present application relates to the technical field of communication, and in particular to a processing method, a communication device and a storage medium.

### BACKGROUND

In the existing specification, the terminal device only supports single-panel uplink transmission at a time. To improve resource utilization, in the scenario of simultaneous uplink transmission of multiple panels, uplink transmission supports spatial division multiplexing and single frequency network.

During the development and implementation of the present application, the inventors discovered that existing methods for determining the transmission configuration indicator (TCI) state of the physical uplink shared channel (PUSCH) in time division multiplexing are not applicable to transmission in spatial division multiplexing and single frequency network.

The preceding description is intended to provide general background information and does not necessarily constitute prior art.

### SUMMARY

The main purpose of the present application is to provide a processing method, a communication device and a storage medium, aiming to provide a method for determining the TCI state of a PUSCH, suitable for transmission in spatial division multiplexing and single frequency network.

To achieve the above objective, the present application provides a processing method applicable to a terminal device (such as a mobile phone), including the following steps:
determining transmission configuration indicator (TCI) state(s) of a physical uplink shared channel (PUSCH) based on downlink information.

Optionally, the downlink information includes radio resource control (RRC) signaling and/or downlink control information (DCI).

Optionally, the DCI is generated or determined by a network device based on beam measurement information reported by a terminal device.

Optionally, the beam measurement information includes at least one group of beam measurement results; and/or the beam measurement results include first content and/or second content.

Optionally, the first content includes at least one of the following: at least one channel state information reference signal resource indicator (CRI), at least one synchronization signal block resource indicator (SSBRI), at least one layer-1 (L1) reference signal received power (RSRP), and at least one L1-signal to interference plus noise ratio (SINR).

Optionally, the second content includes at least one of the following: at least one terminal device capability value, at least one terminal device capability value group, at least one same panel determination value, at least one panel offset value, and at least one panel index value.

Optionally, the method further includes at least one of the following:
the terminal device capability value indicating at least one of a maximum number of supported sounding reference signal (SRS) antenna ports, a maximum number of supported layers, a maximum number of supported antennas, and a maximum number of supported antenna ports;
the terminal device capability value group including a first terminal device capability value and at least one second terminal device capability value;
the same panel determination value indicating whether channel measurement resources are received by a same panel;
the panel offset value indicating an offset of a panel index value corresponding to a panel receiving the channel measurement resources;
the terminal device capability value groups are different;
the terminal device capability values are the same; and
the terminal device capability values are different.

Optionally, the first terminal device capability value indicates a maximum number of supported SRS antenna ports.

Optionally, the second terminal device capability value indicates at least one of a maximum number of supported layers, a maximum number of supported antennas, and a maximum number of supported antenna ports.

Optionally, the method further includes:
determining a transmission mode of the PUSCH based on the RRC signaling and/or the DCI.

Optionally, the RRC signaling includes at least one of PUSCH transmission scheme parameter, PUSCH spatial division multiplexing single frequency network scheme parameter, PUSCH single frequency network scheme parameter, and PUSCH allocation list parameter.

Optionally, determining the transmission mode of the PUSCH based on the RRC signaling and/or the DCI includes at least one of the following:
in response to that the RRC signaling and/or the DCI satisfies a first condition, the transmission mode of the PUSCH is spatial division multiplexing;
in response to that the RRC signaling and/or the DCI satisfies a second condition, the transmission mode of the PUSCH is single frequency network; or
in response to that the RRC signaling satisfies a third condition, the transmission mode of the PUSCH is time division multiplexing.

Optionally, the satisfying the first condition includes at least one of the following:
the PUSCH transmission scheme parameter is set to spatial division multiplexing;
the PUSCH spatial division multiplexing single frequency network scheme parameter is set to spatial division multiplexing;
the PUSCH allocation list parameter is not configured with a repetition number parameter, and the PUSCH single frequency network scheme parameter is not configured; the DCI indicates two TCI states; and an antenna port field in the DCI indicates that DMRS ports are included in two code division multiplexing groups; and
the PUSCH allocation list parameter is not configured with a repetition number parameter, the DCI indicates two TCI states, and the antenna port field in the DCI indicates that the DMRS ports are included in two code division multiplexing groups.

Optionally, the satisfying the second condition includes at least one of the following:
the PUSCH transmission scheme parameter is set to single frequency network;
the PUSCH spatial division multiplexing single frequency network scheme parameter is set to single frequency network;
the PUSCH single frequency network scheme parameter is set to enabled; and
the PUSCH allocation list parameter is not configured with a repetition number parameter, the DCI indicates two TCI states, and the antenna port field in the DCI indicates that the DMRS ports are included in a code division multiplexing group.

Optionally, the satisfying the third condition includes:
the PUSCH transmission scheme parameter is set to time division multiplexing.

Optionally, the step S2 includes:
providing reference signal(s) for a corresponding PUSCH based on TCI state(s) indicated by a value of the SRS resource set indicator field in the DCI; and/or providing reference signal(s) for a corresponding PUSCH based on TCI state(s) indicated by a value of the TCI state indicator parameter in the RRC signaling; and
determining uplink transmission spatial filter based on the reference signal.

Optionally, providing the reference signal for the corresponding PUSCH based on the TCI state indicated by the value of the SRS resource set indicator field in the DCI includes at least one of the following:
the value of SRS resource set indicator field is a first value or a second value, a first TCI state provides a reference signal for a PUSCH associated with a terminal device capability value corresponding to the first TCI state, and the second TCI state provides a reference signal for a PUSCH associated with a terminal device capability value corresponding to the second TCI state;
the value of SRS resource set indicator field is a first value, the first TCI state provides a reference signal for a PUSCH associated with a first terminal device capability value, and the second TCI state provides the reference signal for a PUSCH associated with a second terminal device capability value;
the value of SRS resource set indicator field is a second value, the first TCI state provides a reference signal for a PUSCH associated with a second terminal device capability value, and the second TCI state provides a reference signal for a PUSCH associated with a first terminal device capability value;
the value of SRS resource set indicator field is a first value, the first TCI state provides a reference signal for a PUSCH associated with a first panel index value, and the second TCI state provides a reference signal for a PUSCH associated with the second panel index value;
the value of SRS resource set indicator field is a second value, the first TCI state provides a reference signal for a PUSCH associated with a second panel index value, and the second TCI state provides a reference signal for a PUSCH associated with a first panel index value;
in response to that simultaneous transmission of multiple-panel PUSCH uses the spatial division multiplexing scheme, the value of SRS resource set indicator field is the first value or the second value, the first TCI state provides a reference signal for a first PUSCH, and the second TCI state provides a reference signal for a second PUSCH; or
in response to that simultaneous transmission of multiple-panel PUSCH uses the single frequency network scheme, the value of SRS resource set indicator field is the first value or the second value, and the first TCI state and the second TCI state provide reference signals for the PUSCH.

Optionally, providing the reference signal for the corresponding PUSCH based on the TCI state indicated by the value of the TCI state indicator parameter in the RRC signaling includes:
in response to that simultaneous transmission of multiple-panel PUSCH uses the spatial division multiplexing scheme, the TCI state indicator parameter indicates that TCI states used for transmission of the PUSCH are the first TCI state and the second TCI state, the first TCI state provides a reference signal for the first PUSCH, and the second TCI state provides a reference signal for the second PUSCH; and/or,
in response to that simultaneous transmission of multiple-panel PUSCH uses the single frequency network scheme, the TCI state indicator parameter indicates that TCI states used for transmission of the PUSCH are the first TCI state and the second TCI state, and the first TCI state and the second TCI state provide reference signals for the PUSCH.

The present application further provides a processing method, which can be applied to a network device (such as a base station), including the following step:

S1, transmitting downlink information, so that a terminal device determines transmission configuration indicator (TCI) state(s) of a physical uplink shared channel (PUSCH) based on downlink information.

Optionally, the method further includes at least one of the following:
generating or determining downlink control information (DCI) based on beam measurement information;
adding at least one of PUSCH transmission scheme parameter, PUSCH spatial division multiplexing single frequency network scheme parameter, and PUSCH single frequency network scheme parameter to radio resource control (RRC) signaling; and
transmitting the RRC signaling and/or DCI, so that the terminal device determines a transmission mode of the PUSCH based on the RRC signaling and/or the DCI.

The present application further provides a communication device, including: a memory, a processor, and a processing program stored in the memory and executable on the processor. When executed by the processor, the processing program implements the steps of any of the processing methods described above.

The communication device in the present application can be a terminal device (such as a mobile phone) or a network device (such as a base station); the specific meaning needs to be determined in the context.

The present application further provides a storage medium storing a computer program, and the computer program, when executed by a processor, implements the steps of any of the processing methods described above.

The present application provides a method for determining the transmission configuration indication state of the physical uplink shared channel by determining the transmission configuration indication state of the physical uplink shared channel based on downlink information. This method is applicable to spatial multiplexing and single-frequency network transmission.

### BRIEF DESCRIPTION OF THE DRAWINGS

The accompanying drawings herein are incorporated into and constitute a part of the specification, illustrate embodiments consistent with the present application, and together with the specification, are used to explain the principles of the present application. In order to more clearly illustrate the technical solutions of the embodiments of the present application, the following is a brief introduction to the drawings required for describing the embodiments. Obviously, for those skilled in the art, other drawings can be obtained based on these drawings without inventive work.

FIG. 1 is a schematic diagram of a hardware structure of a mobile terminal according to various embodiments of the present application.

FIG. 2 is an architecture diagram of a communication network system according to an embodiment of the present application.

FIG. 3 is a schematic diagram of the hardware structure of a controller 140 according to the present application.

FIG. 4 is a schematic diagram of the hardware structure of a network node 150 according to the present application.

FIG. 5 is a flow chart of a processing method according to an embodiment of the present application.

FIG. 6 is a flow chart of the processing method according to an embodiment of the present application.

FIG. 7 is a flow chart of the processing method according to an embodiment of the present application.

FIG. 8 is a flow chart of the processing method according to an embodiment of the present application.

FIG. 9 is a flow chart of the processing method according to an embodiment of the present application.

FIG. 10 is a flow chart of the processing method according to an embodiment of the present application.

FIG. 11 is a schematic diagram of an interaction sequence according to an embodiment of the present application.

FIG. 12 is a schematic structural diagram of a processing device according to an embodiment of the present application.

FIG. 13 is a schematic structural diagram of the processing device according to an embodiment of the present application.

FIG. 14 is a schematic structural diagram of a communication device according to an embodiment of the present application.

The implementation of the objectives, functional features, and advantages of the present application will be further illustrated in conjunction with the embodiments and with reference to the accompanying drawings. The aforementioned drawings illustrate specific embodiments of the present application, which will be described in more detail below. These drawings and the accompanying description are not intended to limit the scope of the present application in any way, but rather to illustrate the concepts of the present application for those skilled in the art by reference to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S1 and S2 are used for the purpose of expressing the corresponding content more clearly and concisely, and do not constitute a substantial restriction on the order. When implementing the step, those skilled in the art may execute S2 first and then S1, etc., but these should all be within the scope of protection of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistant (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

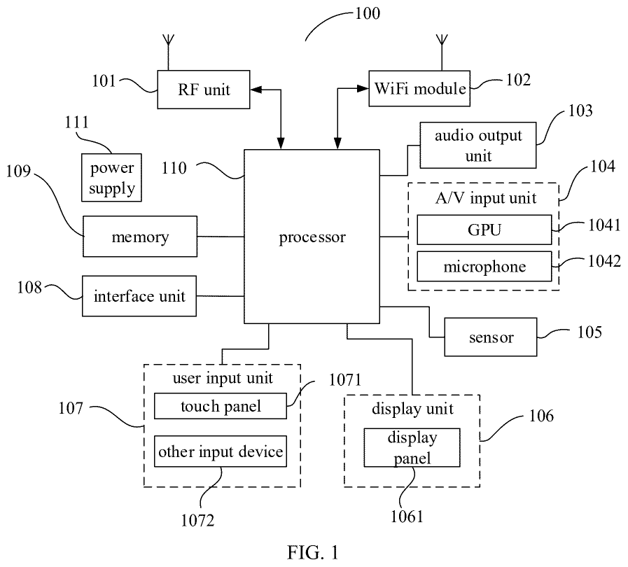

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a denoting mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a denoting mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switch, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and transmits it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 10.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a BLUETOOTH module, or the like, which will not be repeated herein.

In order to facilitate the understanding of the embodiments of the present application, the following describes the communication network system on which the mobile terminal of the present application is based.

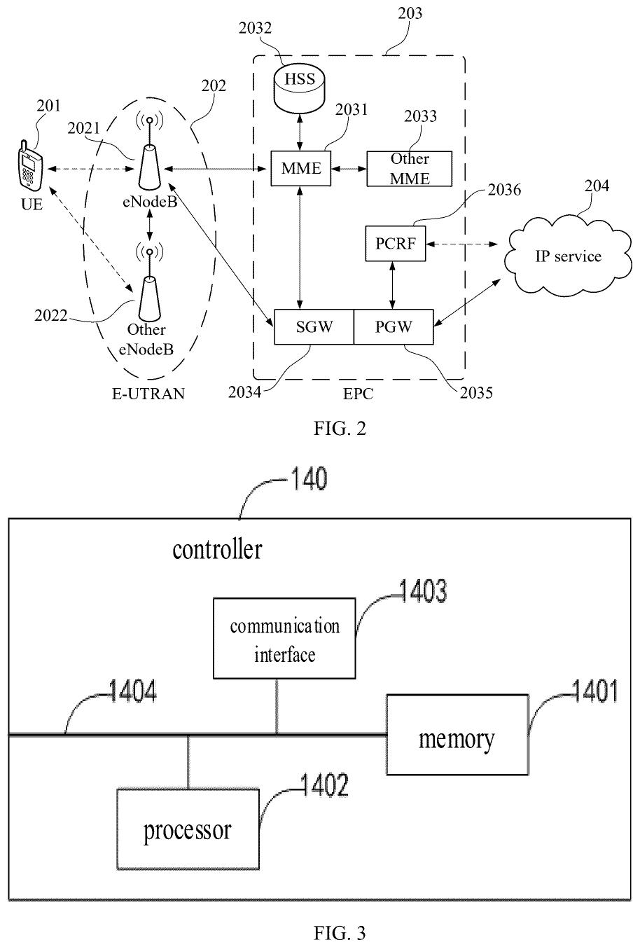

As shown in FIG. 2, FIG. 2 is a communication network system architecture diagram according to an embodiment of the present application. The communication network system is a new radio (NR) system of general mobile communication network technology. The NR system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

FIG. 3 is a schematic diagram of the hardware structure of a controller 140 according to the present application. The controller 140 includes a memory 1401 and a processor 1402. The memory 1401 is used to store a program instruction, and the processor 1402 is used to call the program instruction in the memory 1401 to execute the steps performed by the controller in the embodiments of the above method. The implementation principles and beneficial effects are similar and will not be repeated here.

Optionally, the controller further includes a communication interface 1403, which can be connected to the processor 1402 via a bus 1404. The processor 1402 can control the communication interface 1403 to implement the receiving and transmitting functions of the controller 140.

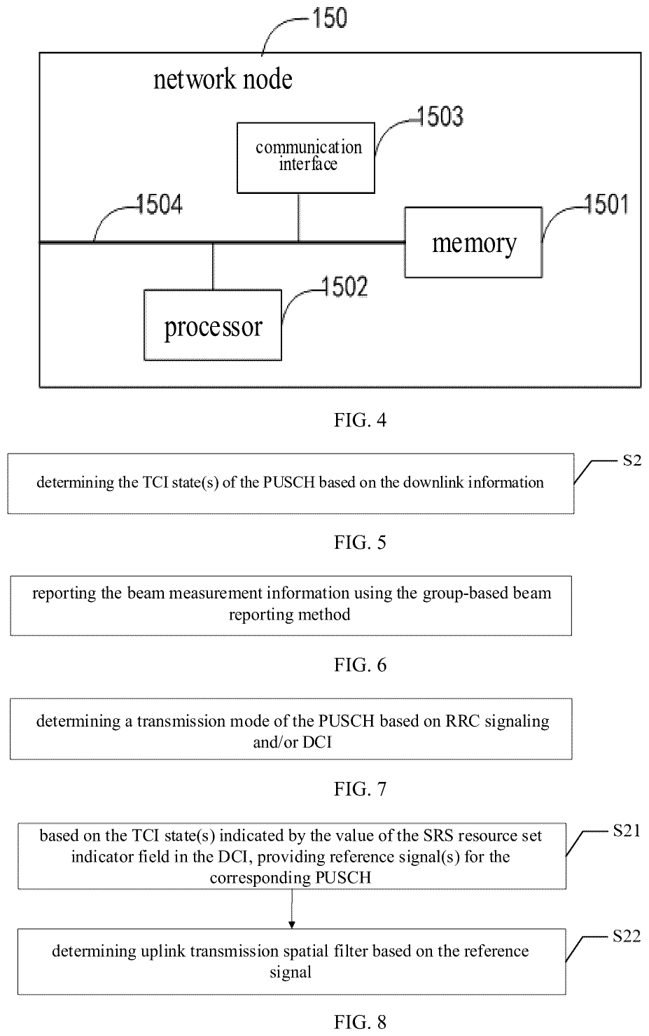

FIG. 4 is a schematic diagram of the hardware structure of a network node 150 according to the present application. The network node 150 includes: a memory 1501 and a processor 1502. The memory 1501 is used to store the program instruction, and the processor 1502 is used to call the program instruction in memory 1501 to execute the steps performed by the first node in the embodiments of the above method. The implementation principles and beneficial effects are similar and will not be repeated here.

Optionally, the controller further includes a communication interface 1503, which can be connected to the processor 1502 via a bus 1504. The processor 1502 can control the communication interface 1503 to implement the receiving and transmitting functions of the network node 150.

The integrated modules implemented in the form of software function modules can be stored in a computer-readable storage medium. The software function modules stored in a storage medium include a number of instructions to cause a computer device (which can be a personal computer, server, or network device, etc.) or a processor to execute some of the steps of the methods of various embodiments of the present application.

In the above embodiments, all or part of the embodiments may be implemented using software, hardware, firmware, or any combination thereof. When implemented using software, all or part of the embodiments may be implemented in the form of a computer program product. A computer program product includes one or more computer instructions. When the computer program instructions are loaded and executed on a computer, the processes or functions according to the embodiments of the present application are generated in whole or in part. The computer may be a general-purpose computer, a special-purpose computer, a computer network, or other programmable device. The computer instruction can be stored in a storage medium or transferred from one storage medium to another. For example, the computer instruction can be transferred from one website, computer, server, or data center to another website, computer, server, or data center via wired (e.g., coaxial cable, optical fiber, digital subscriber line (DSL)) or wireless (e.g., infrared, wireless, microwave, etc.) means. The storage medium can be any available medium that can be accessed by a computer or a data storage device such as a server or data center that includes one or more available media. The available media may be magnetic media (e.g., floppy disk, hard disk, magnetic tape), optical media (e.g., DVD), or semiconductor media (e.g., solid state disk, SSD).

Based on the aforementioned hardware structure of the mobile terminal and communication network system, various embodiments of the present application are provided.

Referring to FIG. 5, FIG. 5 is a flowchart illustrating a processing method according to an embodiment. The processing method of this embodiment of the present application can be applied to a terminal device (such as a mobile phone), and includes the following steps:
S2, determining the TCI state of the PUSCH based on the downlink information.

Optionally, the downlink information includes radio resource control (RRC) signaling and/or downlink control information (DCI).

In a multi-panel simultaneous uplink transmission scenario, a method for determining the TCI state of the PUSCH based on the downlink information is provided.

Optionally, the DCI is generated or determined by the network device based on beam measurement information reported by the terminal device.

Optionally, the terminal device reports the beam measurement information to the network device using a group-based beam reporting method.

Optionally, the beam measurement information includes at least one group of beam measurement results.

Optionally, the beam measurement results include first content and/or second content.

Optionally, the first content includes at least one of the following: at least one channel state information (CSI) reference signal resource indicator (CRI), at least one synchronization signal block (SSB) resource indicator (SSBRI), at least one layer 1 (L1)-reference signal received power (RSRP), and at least one L1-signal to interference plus noise ratio (L1-SINR).

Optionally, the second content includes at least one of the following: at least one terminal device capability value, at least one terminal device capability value group, at least one same panel determination value, at least one panel offset value, and at least one panel index value.

Optionally, during the reporting of beam measurement information, the terminal device may report at least one item of the first content and/or at least one item of the second content, for example:
the terminal device reports at least one of two CSI reference signal (CSI-RS) resource indicators or synchronization signal block resource indicators (SSBRIs), two L1-RSRPs or L1-SINRs, and two terminal device capability values or two terminal device capability value groups;
the terminal device reports at least one of two channel state information reference signal resource indicators or SSBRIs, two L1-RSRPs or L1-SINRs, two terminal device capability values, and a same panel determination value;
the terminal device reports at least one of two channel state information reference signal resource indicators or SSBRIs, two L1-RSRPs or L1-SINRs, two terminal device capability values, and a panel offset value; and
the terminal device reports at least one of two channel state information reference signal resource indicators or SSBRIs, two L1-RSRPs or L1-SINRs, and two panel index values.

Optionally, the method further includes at least one of the following:
a terminal device capability value indicating at least one of the following: the maximum number of supported sounding reference signal (SRS) antenna ports, the maximum number of supported layers, the maximum number of supported antennas, and the maximum number of supported antenna ports;
a terminal device capability value group including a first terminal device capability value and at least one second terminal device capability value;
a same-panel determination value indicating whether each channel measurement resource is received by the same panel;
a panel offset value indicating an offset value of a panel index value corresponding to the panel receiving each channel measurement resource;
the terminal device capability value groups are different;
the terminal device capability values are the same; and
the terminal device capability values are different.

Optionally, the terminal device capability value indicates at least one of the maximum number of supported SRS antenna ports, the maximum number of supported layers, the maximum number of supported antennas, and the maximum number of supported antenna ports.

Optionally, the terminal device capability value group includes a first terminal device capability value and at least one second terminal device capability value. Optionally, the first terminal device capability value indicates the maximum number of supported SRS antenna ports.

Optionally, the second terminal device capability value indicates at least one of the following: the maximum number of supported layers, the maximum number of supported antennas, and the maximum number of supported antenna ports.

Optionally, the two terminal device capability values may be the same or different.

Optionally, the two terminal device capability value groups are different.

Optionally, the same panel determination value indicates whether the two channel measurement resources are received by the same panel.

Optionally, the panel offset value indicates the offset between the panel index values of the two panels receiving the two channel measurement resources.

This embodiment, through the above solution, specifically determines the TCI state of the PUSCH based on downlink information, providing a method for determining the TCI state of the PUSCH. This method is applicable to both spatial division multiplexing and single frequency network transmission. In scenarios where multi-panel uplink transmission, the beam measurement reporting method is enhanced.

Based on the above embodiment of the present application, the present embodiment further discloses a method for reporting beam measurement information. Referring to FIG. 6, FIG. 6 is a flow chart illustrating a processing method according to an embodiment. The processing method further includes:
reporting the beam measurement information using a group-based beam reporting method.

Optionally, the beam measurement information includes at least one group of beam measurement results.

Optionally, the beam measurement results include first content and/or second content.

Optionally, the first content includes at least one of the following: at least one CSI-RS resource indicator, at least one SSBRI, at least one L1-RSRP, and at least one L1-SINR.

Optionally, the second content includes at least one of the following: at least one terminal device capability value, at least one terminal device capability value group, at least one same panel determination value, at least one panel offset value, and at least one panel index value.

Optionally, the terminal device reports the beam measurement information using a group-based beam reporting method. Each group of beam measurement results may include the first content and/or the second content.

Optionally, the terminal device reports two CSI-RS resource indicators (CRIs) or SSBRIs, two L1-RSRPs or L1-SINRs, and two terminal device capability values.

Optionally, the terminal device reports two CRIs or SSBRIs, two L1-RSRPs or L1-SINRs, and two terminal device capability value groups.

Optionally, the terminal device reports two CRIs or SSBRIs, two L1-RSRPs or L1-SINRs, two terminal device capability values, and a same panel determination value.

Optionally, the terminal device reports two CRIs or SSBRIs, two L1-RSRPs or L1-SINRs, two terminal device capability values, and a panel offset value.

Optionally, the terminal device reports two CRIs or SSBRIs, two L1-RSRPs or L1-SINRs, and two panel index values.

Optionally, at least one terminal device capability value is included in the terminal device capability value set, and each terminal device capability value indicates at least one of the maximum number of supported SRS antenna port, the maximum number of supported layers, the maximum supported rank, the maximum number of supported antennas, the maximum number of supported CSI-RS antenna ports, the maximum supported demodulation reference signal (DMRS) antenna ports, and the maximum number of supported antenna ports. When the terminal device uses two panels to perform multi-panel uplink simultaneous transmission, the two panels respectively correspond to one terminal device capability value in the terminal device capability value set, that is, two terminal device capability values in total.

Optionally, at least one of the features indicated by the terminal device capability values corresponding to the two panels is different, so that the terminal device capability values corresponding to the two panels are different. For example, the maximum number of layers supported in the feature indicated by the terminal device capability value corresponding to the first panel is 4, and/or the maximum number of layers supported in the feature indicated by the terminal device capability value corresponding to the second panel is 2. Therefore, the terminal device capability value corresponding to the first panel is different from the terminal device capability value corresponding to the second panel.

Optionally, a group-based beam reporting parameter (e.g., groupBasedBeamReporting-r18) is added to the channel state information reporting configuration information element (e.g., CSI-ReportConfig). The group-based beam reporting parameter is set to enabled, indicating that the terminal device reports the beam measurement information in accordance with the group-based beam reporting method.

Optionally, if the reporting quantity parameter (e.g., reportQuantity) is set to the CRI and RSRP index value (e.g., cri-RSRP-Index) or the SSB index value and RSRP index value (e.g., ssb-Index-RSRP-Index), in one CSI report, several groups of beam measurement results are included, one bit is used to indicate the CSI resource set corresponding to the channel measurement resource corresponding to the largest L1-RSRP, and the order of the channel state information resource sets corresponding to the two channel measurement resources in other groups is the same as the order of the channel state information resource sets in the group containing the largest L1-RSRP. For each group of beam measurement results, the terminal device reports two CRIs or SSBRIs, two L1-RSRPs, and two terminal device capability values, as shown in Table 1.

TABLE 1
First Example of Beam Information Reporting

| Channel state information | | | |
|---|---|---|---|
| resource set ID with the | | Channel measurement | Channel measurement |
| largest L1-RSRP | group ID | resource ID in set #0 | resource ID in set #1 |
| Channel state information | group ID#0 | Terminal device | Terminal device |
| resource set ID#0 | | capability value m | capability value n |
| | | SSBRI/CRI#i, | SSBRI/CRI#i + 3, |
| | | L1-RSRP(7 bit) | L1-RSRP(4 bit) |
| | group ID#1 | Terminal device | Terminal device |
| | | capability value m | capability value n |
| | | SSBRI/CRI#i + 2, | SSBRI/CRI#i + 8, |
| | | L1-RSRP(4 bit) | L1-RSRP(4 bit) |
| | group ID#2 | Terminal device | Terminal device |
| | | capability value m | capability value n |
| | | SSBRI/CRI#i + 5, | SSBRI/CRI#i + 10, |
| | | L1-RSRP(4 bit) | L1-RSRP(4 bit) |
| | group ID#3 | Terminal device | Terminal device |
| | | capability value m | capability value n |
| | | SSBRI/CRI#i + 7, | SSBRI/CRI#i + 12, |
| | | L1-RSRP(4 bit) | L1-RSRP(4 bit) |

Optionally, a group of CRI or SSBRI, L1-RSRP and terminal device capability value corresponds to a channel measurement resource in a channel state information resource set. The terminal device capability value is determined by a panel that receives the channel measurement resource and indicates at least one of the following characteristics of the panel: the maximum number of supported SRS antenna ports, the maximum number of supported layers, the maximum supported rank, the maximum number of supported antennas, the maximum number of supported CSI-RS antenna ports and the maximum number of supported antenna ports. An example of the arrangement order of each CSI field in a CSI report is shown in Table 2.

TABLE 2
First example of the arrangement order of CSI fields in a CSI report

| CSI reporting | |
|---|---|
| number | CSI field |
| CSI report #n | Channel state information resource set ID |
| | First SSBRI/CRI of group ID#0, optional reporting |
| | Second SSBRI/CRI of group ID#0, optional reporting |
| | First SSBRI/CRI of group ID#1, optional reporting |
| | Second SSBRI/CRI of group ID#1, optional reporting |
| | First SSBRI/CRI of group ID#2, optional reporting |
| | Second SSBRI/CRI of group ID#2, optional reporting |
| | First SSBRI/CRI of group ID#3, optional reporting |
| | Second SSBRI/CRI of group ID#3, optional reporting |
| | RSRP corresponding to the first SSBRI/CRI of group ID#0 |
| | Differential RSRP corresponding to the second SSBRI/CRI of group |
| | ID#0 |
| | Differential RSRP corresponding to the first SSBRI/CRI of group |
| | ID#1, optional reporting |
| | Differential RSRP corresponding to the second SSBRI/CRI of group |
| | ID#1, optional reporting |
| | Differential RSRP corresponding to the first SSBRI/CRI of group |
| | ID#2, optional reporting |
| | Differential RSRP corresponding to the second SSBRI/CRI of group |
| | ID#2, optional reporting |
| | Differential RSRP corresponding to the first SSBRI/CRI of group |
| | ID#3, optional reporting |
| | Differential RSRP corresponding to the second SSBRI/CRI of group |
| | ID#3, optional reporting |
| | Terminal device capability value corresponding to the first |
| | SSBRI/CRI of group ID#0, optional reporting |
| | Terminal device capability value corresponding to the second |
| | SSBRI/CRI of group ID#0, optional reporting |
| | Terminal device capability value corresponding to the first |
| | SSBRI/CRI of group ID#1, optional reporting |
| | Terminal device capability value corresponding to the second |
| | SSBRI/CRI of group ID#1, optional reporting |
| | Terminal device capability value corresponding to the first |
| | SSBRI/CRI of group ID#2, optional reporting |
| | Terminal device capability value corresponding to the second |
| | SSBRI/CRI of group ID#2, optional reporting |
| | Terminal device capability value corresponding to the first |
| | SSBRI/CRI of group ID#3, optional reporting |
| | Terminal device capability value corresponding to the second |
| | SSBRI/CRI of group ID#3, optional reporting |

Optionally, if the reporting quantity parameter (e.g., reportQuantity) is set to CRI and SINR index value (e.g., cri-SINR-Index) or SSB index value and SINR index value (e.g., ssb-Index-SINR-Index), in one CSI report, several groups of beam measurement results are included. For each group of beam measurement results, the terminal device reports two CRIs or SSBRIs, two L1-SINRs, and two terminal device capability values. Optionally, a group of CRI or SSBRI, L1-SINR and terminal device capability value corresponds to a channel measurement resource in a CSI resource set. The terminal device capability value is determined by a panel that receives the channel measurement resource and indicates at least one of the following characteristics of the panel: the maximum number of supported SRS antenna ports, the maximum number of supported layers, the maximum supported rank, the maximum number of supported antennas, the maximum number of supported CSI-RS antenna ports, the maximum number of supported DMRS antenna ports and the maximum number of supported antenna ports.

Through the above solution, this embodiment provides a method for reporting the beam measurement information including two terminal device capability values. This method includes: the terminal device reporting two CRIs or SSBRIs, two L1-RSRPs or L1-SINRs, and two terminal device capability values, thereby improving the applicability of the beam measurement reporting method to support multi-panel simultaneous transmission scenarios.

Based on any of the above embodiments of the present application, this embodiment further discloses a processing method.

Optionally, the terminal device capability value group includes a first terminal device capability value and/or at least one second terminal device capability value. Optionally, the first terminal device capability value indicates the maximum number of supported SRS antenna ports. Optionally, the second terminal device capability value indicates at least one of the following: the maximum number of supported layers, the maximum number of supported antennas, and the maximum number of supported antenna ports.

Optionally, the terminal device capability value group includes a first terminal device capability value and/or at least one second terminal device capability value. Optionally, the first terminal device capability value is used to indicate the maximum number of SRS antenna ports supported, and the at least one second terminal device capability value respectively indicates at least one of the following: the maximum number of supported layers, the maximum supported rank, the maximum number of supported antennas, the maximum number of supported CSI-RS antenna ports, the maximum number of supported DMRS antenna ports, and the maximum number of supported antenna ports. When the terminal device uses two panels for simultaneous uplink transmission on multi-panel, the two panels each correspond to a terminal device capability value group, that is, a total of two groups of terminal device capability values.

Optionally, at least one feature among the features indicated by the terminal device capability values included in the terminal device capability value groups corresponding to the two panels is different, so that the terminal device capability value groups corresponding to the two panels are different. For example, the maximum number of layers supported in the features indicated by the terminal device capability value group corresponding to the first panel is 4, and/or the maximum number of supported layers in the features indicated by the terminal device capability value group corresponding to the second panel is 2. Therefore, the terminal device capability value group corresponding to the first panel is different from the terminal device capability value group corresponding to the second panel.

Optionally, a group-based beam reporting parameter (e.g., groupBasedBeamReporting-r18) is added to the channel state information reporting configuration information element (e.g., CSI-ReportConfig). The group-based beam reporting parameter is set to enabled, indicating that the terminal device reports the beam measurement information using the group-based beam reporting method.

Optionally, if the reporting quantity parameter (e.g., reportQuantity) is set to CRI and RSRP index value (e.g., cri-RSRP-Index) or SSB index value and RSRP index value (e.g., ssb-Index-RSRP-Index), in one CSI report, several groups of beam measurement results are included, and 1 bit is used to indicate the CSI resource set corresponding to the channel measurement resource corresponding to the largest L1-RSRP. The order of the CSI resource sets corresponding to the two channel measurement resources in other groups is the same as the order of the CSI resource sets in the group containing the largest L1-RSRP. For each group of beam measurement results, the terminal device reports two CRIs or SSBRIs, two L1-RSRPs, and two terminal device capability value groups, as shown in Table 3.

TABLE 3
Second example of beam information reporting

| Channel state information | | | |
|---|---|---|---|
| resource set ID with the | | Channel measurement | Channel measurement |
| largest L1-RSRP | group ID | resources ID in set #0 | resources ID in set #1 |
| Channel state information | group ID#0 | Terminal device | Terminal device |
| resource set ID#0 | | capability value | capability value |
| | | group m | group n |
| | | SSBRI/CRI#i, | SSBRI/CRI#i + 3, |
| | | L1-RSRP(7 bit) | L1-RSRP(4 bit) |
| | group ID#1 | Terminal device | Terminal device |
| | | capability value | capability value |
| | | group m | group n |
| | | SSBRI/CRI#i + 2, | SSBRI/CRI#i + 8, |
| | | L1-RSRP(4 bit) | L1-RSRP(4 bit) |
| | group ID#2 | Terminal device | Terminal device |
| | | capability value | capability value |
| | | group m | group n |
| | | SSBRI/CRI#i + 5, | SSBRI/CRI#i + 10, |
| | | L1-RSRP(4 bit) | L1-RSRP(4 bit) |
| | group ID#3 | Terminal device | Terminal device |
| | | capability value | capability value |
| | | group m | group n |
| | | SSBRI/CRI#i + 7, | SSBRI/CRI#i + 12, |
| | | L1-RSRP(4 bit) | L1-RSRP(4 bit) |

Optionally, a group of CRI or SSBRI, L1-RSRP, and terminal device capability value group corresponds to a channel measurement resource in a channel state information resource set. The terminal device capability value group is determined by the panel receiving the channel measurement resource and indicates the maximum number of supported SRS antenna ports of the panel and at least one of the following: the maximum number of supported layers, maximum supported rank, the maximum number of supported antennas, the maximum number of supported CSI-RS antenna ports, the maximum number of supported DMRS antenna ports, and the maximum number of supported antenna ports. An example of the order of CSI fields in a CSI report is shown in Table 4.

TABLE 4
Second Example of the Order of CSI Fields in a CSI Report reporting

| CSI reporting | |
|---|---|
| number | CSI field |
| CSI reporting #n | Channel state information resource set ID |
| | First SSBRI/CRI of group ID#0, optional reporting |
| | Second SSBRI/CRI of group ID#0, optional reporting |
| | First SSBRI/CRI of group ID#1, optional reporting |
| | Second SSBRI/CRI of group ID#1, optional reporting |
| | First SSBRI/CRI of group ID#2, optional reporting |
| | Second SSBRI/CRI of group ID#2, optional reporting |
| | First SSBRI/CRI of group ID#3, optional reporting |
| | Second SSBRI/CRI of group ID#3, optional reporting |
| | RSRP corresponding to the first SSBRI/CRI of group ID#0 |
| | Differential RSRP corresponding to the second SSBRI/CRI of group |
| | ID#0 |
| | Differential RSRP corresponding to the first SSBRI/CRI of group |
| | ID#1, optional reporting |
| | Differential RSRP corresponding to the second SSBRI/CRI of group |
| | ID#1, optional reporting |
| | Differential RSRP corresponding to the first SSBRI/CRI of group |
| | ID#2, optional reporting |
| | Differential RSRP corresponding to the second SSBRI/CRI of group |
| | ID#2, optional reporting |
| | Differential RSRP corresponding to the first SSBRI/CRI of group |
| | ID#3, optional reporting |
| | Differential RSRP corresponding to the second SSBRI/CRI of group |
| | ID#3, optional reporting |
| | Terminal device capability value group corresponding to the first |
| | SSBRI/CRI of group ID#0, optional reporting |
| | Terminal device capability value group corresponding to the second |
| | SSBRI/CRI of group ID#0, optional reporting |
| | Terminal device capability value group corresponding to the first |
| | SSBRI/CRI of group ID#1, optional reporting |
| | Terminal device capability value group corresponding to the second |
| | SSBRI/CRI of group ID#1, optional reporting |
| | Terminal device capability value group corresponding to the first |
| | SSBRI/CRI of group ID#2, optional reporting |
| | Terminal device capability value group corresponding to the second |
| | SSBRI/CRI of group ID#2, optional reporting |
| | Terminal device capability value group corresponding to the first |
| | SSBRI/CRI of group ID#3, optional reporting |
| | Terminal device capability value group corresponding to the second |
| | SSBRI/CRI of group ID#3, optional reporting |

Optionally, if the reporting quantity parameter (e.g., reportQuantity) is set to CRI and SINR index value (e.g., cri-SINR-Index) or SSB index value and SINR index value (e.g., ssb-Index-SINR-Index), in one CSI report, several groups of beam measurement results are included. For each group of beam measurement results, the terminal device reports two CRIs or SSBRIs, two L1-SINRs, and two terminal device capability value groups. Optionally, a group of CRI or SSBRI, L1-SINR and terminal device capability value group corresponds to a channel measurement resource in a channel state information resource set. The terminal device capability value group is determined by a panel that receives the channel measurement resource and indicates the maximum number of supported SRS antenna ports of the panel and at least one of the following: the maximum number of supported layers, the maximum supported rank, the maximum number of supported antennas, the maximum number of supported CSI-RS antenna ports, the maximum member of supported DMRS antenna ports and the maximum number of supported antenna ports.

This embodiment, through the above-mentioned solution, provides a method for reporting beam measurement information including two terminal device capability value groups. This method includes the terminal device reporting two CRIs or SSBRIs, two L1-RSRPs or L1-SINRs, and two terminal device capability value groups, improving the applicability of beam measurement reporting to support multi-panel simultaneous transmission scenarios.

Based on any of the above-mentioned embodiments of the present application, this embodiment further discloses a processing method.

Optionally, at least one terminal device capability value is included in the terminal device capability value set, and each terminal device capability value indicates at least one of the following: the maximum number of supported SRS antenna ports, the maximum number of supported layers, the maximum supported rank, the maximum number of supported antennas, the maximum number of supported CSI-RS antenna ports, the maximum number of supported DMRS antenna ports, and the maximum number of supported antenna ports. When the terminal device uses two panels for simultaneous uplink transmission on multi-panel, the two panels each correspond to one terminal device capability value in the terminal device capability value set, that is, a total of two terminal device capability values.

Optionally, the features indicated by the terminal device capability values corresponding to the two panels may be the same or different, that is, the terminal device capability values corresponding to the two panels may be the same or different. When the terminal device capability values corresponding to the two panels receiving the two channel measurement resources are the same, the same panel determination value is used to indicate to the network device that the two panels are different.

Optionally, a group-based beam reporting parameter (e.g., groupBasedBeamReporting-r18) is added to the channel state information reporting configuration information element (e.g., CSI-ReportConfig). The group-based beam reporting parameter is set to enabled, indicating that the terminal device reports the beam measurement information through the group-based beam reporting method. For reporting the beam measurement information:
optionally, if the reporting quantity parameter (e.g., reportQuantity) is set to CRI and RSRP index value (e.g., cri-RSRP-Index) or SSB index value and RSRP index value (e.g., ssb-Index-RSRP-Index), in one CSI report, several groups of beam measurement results are included, and 1 bit is used to indicate the channel state information resource set corresponding to the channel measurement resource corresponding to the largest L1-RSRP. The order of the channel state information resource sets corresponding to the two channel measurement resources in other groups is the same as the order of the channel state information resource sets in the group containing the largest L1-RSRP. For each group of beam measurement results, the terminal device reports two CRIs or SSBRIs, two L1-RSRPs, two terminal device capability values and the same panel determination value, as shown in Table 5.

TABLE 5
Third example of Beam information reporting state

| | | Channel | Channel | |
|---|---|---|---|---|
| Channel state information | | measurement | measurement | Same panel |
| resource set ID with the | group | resource ID in | resource ID in | determination |
| largest L1-RSRP | ID | set #0 | set #1 | value |
| Channel state information | group | Terminal device | Terminal device | Same panel |
| resource set ID#0 | ID#0 | capability value m | capability value n | determination |
| | | SSBRI/CRI#i, | SSBRI/CRI#i + 3, | value x |
| | | L1-RSRP(7 bit) | L1-RSRP(4 bit) | |
| | group | Terminal device | Terminal device | Same panel |
| | ID#1 | capability value m | capability value n | determination |
| | | SSBRI/CRI#i + 2, | SSBRI/CRI#i + 8, | value x |
| | | L1-RSRP(4 bit) | L1-RSRP(4 bit) | |
| | group | Terminal device | Terminal device | Same panel |
| | ID#2 | capability value m | capability value n | determination |
| | | SSBRI/CRI#i + 5, | SSBRI/CRI#i + 10, | value y |
| | | L1-RSRP(4 bit) | L1-RSRP(4 bit) | |
| | group | Terminal device | Terminal device | Same panel |
| | ID#3 | capability value m | capability value n | determination |
| | | SSBRI/CRI#i + 7, | SSBRI/CRI#i + 12, | value y |
| | | L1-RSRP(4 bit) | L1-RSRP(4 bit) | |

Optionally, a group of CRI or SSBRI, L1-RSRP, and terminal device capability value corresponds to a channel measurement resource in a channel state information resource set, the terminal device capability value is determined by a panel receiving the channel measurement resource, and indicates at least one of the following characteristics of the panel: the maximum number of supported SRS antenna ports, the maximum number of supported layers, the maximum supported rank, the maximum number of supported antennas, the maximum number of supported CSI-RS antenna ports, the maximum number of supported DMRS antenna ports, and the maximum number of supported antenna ports. The same panel determination value is used to indicate whether two channel measurement resources in the group are received by the same panel. Optionally, if the same panel determination value is 1, it indicates that the two channel measurement resources are received by the same panel, and/or, if the same panel determination value is 0, it indicates that the two channel measurement resources are received by different panels. Optionally, if the same panel determination value is 0, it indicates that the two channel measurement resources are received by the same panel, and/or, if the same panel determination value is 1, it indicates that the two channel measurement resources are received by different panels. An example of the arrangement order of each CSI field in a CSI report is shown in Table 6.

TABLE 6
Third example of the arrangement order of CSI fields in a CSI report

| CSI reporting | |
|---|---|
| number | CSI field |
| CSI reporting #n | Channel state information resource set ID |
| | First SSBRI/CRI of group ID#0, optional reporting |
| | Second SSBRI/CRI of group ID#0, optional reporting |
| | First SSBRI/CRI of group ID#1, optional reporting |
| | Second SSBRI/CRI of group ID#1, optional reporting |
| | First SSBRI/CRI of group ID#2, optional reporting |
| | Second SSBRI/CRI of group ID#2, optional reporting |
| | First SSBRI/CRI of group ID#3, optional reporting |
| | Second SSBRI/CRI of group ID#3, optional reporting |
| | RSRP corresponding to the first SSBRI/CRI of group ID#0 |
| | Differential RSRP corresponding to the second SSBRI/CRI of group |
| | ID#0 |
| | Differential RSRP corresponding to the first SSBRI/CRI of group |
| | ID#1, optional reporting |
| | Differential RSRP corresponding to the second SSBRI/CRI of group |
| | ID#1, optional reporting |
| | Differential RSRP corresponding to the first SSBRI/CRI of group |
| | ID#2, optional reporting |
| | Differential RSRP corresponding to the second SSBRI/CRI of group |
| | ID#2, optional reporting |
| | Differential RSRP corresponding to the first SSBRI/CRI of group |
| | ID#3, optional reporting |
| | Differential RSRP corresponding to the second SSBRI/CRI of group |
| | ID#3, optional reporting |
| | Terminal device capability value corresponding to the first |
| | SSBRI/CRI of group ID#0, optional reporting |
| | Terminal device capability value corresponding to the second |
| | SSBRI/CRI of group ID#0, optional reporting |
| | Terminal device capability value corresponding to the first |
| | SSBRI/CRI of group ID#1, optional reporting |
| | Terminal device capability value corresponding to the second |
| | SSBRI/CRI of group ID#1, optional reporting |
| | Terminal device capability value corresponding to the first |
| | SSBRI/CRI of group ID#2, optional reporting |
| | Terminal device capability value corresponding to the second |
| | SSBRI/CRI of group ID#2, optional reporting |
| | Terminal device capability value corresponding to the first |
| | SSBRI/CRI of group ID#3, optional reporting |
| | Terminal device capability value corresponding to the second |
| | SSBRI/CRI of group ID#3, optional reporting |
| | Same panel determination value of group ID#0, optional reporting |
| | Same panel determination value of group ID#1, optional reporting |
| | Same panel determination value of group ID#2, optional reporting |
| | Same panel determination value of group ID#3, optional reporting |

Optionally, if the reporting quantity parameter (e.g., reportQuantity) is set to CRI and SINR index value (e.g., cri-SINR-Index) or SSB index value and SINR index value (e.g., ssb-Index-SINR-Index), in one CSI report, several groups of beam measurement results are included. For each group of beam measurement results, the terminal device reports two CRIs or SSBRIs, two L1-SINRs, two terminal device capability values, and one same panel determination value. Optionally, a group of CRI or SSBRI, L1-SINR, and terminal device capability value corresponds to a channel measurement resource in a channel state information resource set. The terminal device capability value is determined by a panel receiving the channel measurement resource, and indicates at least one of the following characteristics of the panel: the maximum number of supported SRS antenna ports, the maximum number of supported layers, the maximum supported ranks, the maximum number of supported antennas, the maximum number of supported CSI-RS antenna ports, the maximum number of supported DMRS antenna ports, and the maximum number of supported antenna ports. The same panel determination value is used to indicate whether two channel measurement resources in the group are received by the same panel. For example, if the same panel determination value is 1, it indicates that the two channel measurement resources are received by the same panel, and/or, if the same panel determination value is 0, it indicates that the two channel measurement resources are received by different panels. Alternatively, if the same panel determination value is 0, it indicates that the two channel measurement resources are received by the same panel, and/or, if the same panel determination value is 1, it indicates that the two channel measurement resources are received by different panels.

Through the above solution, this embodiment provides a method for reporting beam measurement information including two terminal device capability values and the same panel determination value, including the terminal device reporting two CRIs or SSBRIs, two L1-RSRPs or L1-SINRs, two terminal device capability values and one same panel determination value, thereby improving the applicability of the beam measurement reporting method to support multi-panel simultaneous transmission scenarios.

Based on any of the above embodiments of the present application, this embodiment further discloses a processing method.

Optionally, at least one terminal device capability value is included in the terminal device capability value set, and each terminal device capability value indicates at least one of the following characteristics: the maximum number of supported SRS antenna ports, the maximum number of supported layers, the maximum supported rank, the maximum number of supported antennas, the maximum number of supported CSI-RS antenna ports, the maximum number of supported DMRS antenna ports, and the maximum number of supported antenna ports. When the terminal device uses two panels for multi-panel uplink simultaneous transmission, the two panels each correspond to one terminal device capability value in the terminal device capability value set, that is, a total of two terminal device capability values.

Optionally, the features indicated by the terminal device capability values corresponding to the two panels may be the same or different, that is, the terminal device capability values corresponding to the two panels may be the same or different. When the terminal device capability values corresponding to the two panels receiving the two channel measurement resources are the same, the panel offset value is used to indicate to the network device the offset value of the panel index values of the two panels.

Optionally, a group-based beam reporting parameter (e.g., groupBasedBeamReporting-r18) is added to the channel state information reporting configuration information element (e.g., CSI-ReportConfig). The group-based beam reporting parameter is set to enabled, indicating that the terminal device reports the beam measurement information in accordance with the group-based beam reporting method.

Optionally, if the reporting quantity parameter (e.g., reportQuantity) is set to CRI and RSRP index value (e.g., cri-RSRP-Index) or SSB index value and RSRP index value (e.g., ssb-Index-RSRP-Index), in one CSI report, several groups of beam measurement results are included, and one bit is used to indicate the channel state information resource set corresponding to the channel measurement resource corresponding to the largest L1-RSRP. The order of the channel state information resource sets corresponding to the two channel measurement resources in other groups is the same as the order of the channel state information resource sets in the group containing the largest L1-RSRP. For each group of beam measurement results, the terminal device reports two CRIs or SSBRIs, two L1-RSRPs, two terminal device capability values and a panel offset value, as shown in Table 7.

TABLE 7
Fourth example of beam information reporting state

| | | Channel | Channel | |
|---|---|---|---|---|
| Channel state information | | measurement | measurement | |
| resource set ID with the | group | resource ID in | resource ID in | Panel offset |
| largest L1-RSRP | ID | set #0 | set #1 | value |
| Channel state information | group | Terminal device | Terminal device | Panel offset |
| resource set ID#0 | ID#0 | capability value m | capability value n | value a |
| | | SSBRI/CRI#i, | SSBRI/CRI#i + 3, | |
| | | L1-RSRP(7 bit) | L1-RSRP(4 bit) | |
| | group | Terminal device | Terminal device | Panel offset |
| | ID#1 | capability value m | capability value n | value b |
| | | SSBRI/CRI#i + 2, | SSBRI/CRI#i + 8, | |
| | | L1-RSRP(4 bit) | L1-RSRP(4 bit) | |
| | group | Terminal device | Terminal device | Panel offset |
| | ID#2 | capability value m | capability value n | value c |
| | | SSBRI/CRI#i + 5, | SSBRI/CRI#i + 10, | |
| | | L1-RSRP(4 bit) | L1-RSRP(4 bit) | |
| | group | Terminal device | Terminal device | Panel offset |
| | ID#3 | capability value m | capability value n | value d |
| | | SSBRI/CRI#i + 7, | SSBRI/CRI#i + 12, | |
| | | L1-RSRP(4 bit) | L1-RSRP(4 bit) | |

Optionally, a group of CRI or SSBRI, L1-RSRP, and terminal device capability value corresponds to a channel measurement resource in one channel state information resource set. The terminal device capability value is determined by a panel receiving the channel measurement resource, and indicates at least one of the following characteristics of the panel: the maximum number of supported SRS antenna ports, the maximum number of supported layers, the maximum supported rank, the maximum number of supported antennas, the maximum supported number of CSI-RS antenna ports, the maximum number of supported DMRS antenna ports, and the maximum number of supported antenna ports. The panel offset value is used to indicate the offset value of the panel index values of the two panels receiving the two channel measurement resources in the group. Optionally, in one group, the panel offset value is the difference between the panel index values of the panel that receives the channel measurement resource in the front order and the panel that receives the channel measurement resource in the back order. Optionally, in one group, the panel offset value is the absolute value of the difference between the panel index values of the panels that receive the two channel measurement resources, and the panel offset value determination value is used to indicate the panel with the larger panel index value of the two panels. If the panel offset value determination value is 1, it indicates that the panel index value of the panel that receives the channel measurement resource in the front order is greater than that of the panel that receives the channel measurement resource in the back order, and/or if the panel offset value determination value is 0, it indicates that the panel index value of the panel that receives the channel measurement resource in the front order is less than that of the panel that receives the channel measurement resource in the back order. Alternatively, if the panel offset value determination value is 0, it means that the panel index value of the panel that receives the channel measurement resource in the front order is greater than that of the panel that receives the channel measurement resource in the back order, and/or, if the panel offset value determination value is 1, it means that the panel index value of the panel that receives the channel measurement resource in the front order is smaller than that of the panel that receives the channel measurement resource in the back order.

Optionally, if the reporting quantity parameter (e.g., reportQuantity) is set to CRI and SINR index value (e.g., cri-SINR-Index) or SSB index value and SINR index value (e.g., ssb-Index-SINR-Index), in one CSI report, several groups of beam measurement results are included. For each group of beam measurement results, the terminal device reports two CRIs or SSBRIs, two L1-SINRs, two terminal device capability values, and one panel offset value. Optionally, a group of CRI or SSBRI, L1-SINR, and terminal device capability value corresponds to the channel measurement resource in one channel state information resource set. The terminal device capability value is determined by a panel that receives the channel measurement resource, and indicates at least one of the following characteristics of the panel: the maximum number of supported SRS antenna ports, the maximum number of supported layers, the maximum supported rank, the maximum number of supported antennas, the maximum number of supported CSI-RS antenna ports, the maximum number of supported DMRS antenna ports, and the maximum number of supported antenna ports. The panel offset value is used to indicate the offset value of the panel index values of the two panels receiving the two channel measurement resources in the group. Optionally, in a group, the panel offset value is the difference between the panel index values of the panel receiving the channel measurement resources in the front order and the panel receiving the channel measurement resources in the back order. Optionally, in a group, the panel offset value is the absolute value of the difference between the panel index values of the panels receiving the two channel measurement resources, and the panel offset value determination value is used to indicate the panel with the larger panel index value among the two panels. If the panel offset value determination value is 1, it indicates that the panel index value of the panel receiving the channel measurement resources in the front order is greater than the panel index value of the panel receiving the channel measurement resources in the back order, and/or, if the panel offset value determination value is 0, it indicates that the panel index value of the panel receiving the channel measurement resources in the front order is smaller than the panel index value of the panel receiving the channel measurement resources in the back order. Alternatively, if the panel offset value determination value is 0, it indicates that the panel index value of the panel receiving the channel measurement resources in the front order is greater than the panel index value of the panel receiving the channel measurement resources in the back order, and/or, if the panel offset value determination value is 1, it indicates that the panel index value of the panel receiving the channel measurement resources in the front order is smaller than the panel index value of the panel receiving the channel measurement resources in the back order.

Through the above solution, this embodiment provides a method for reporting beam measurement information including two terminal device capability values and a panel offset value, including the terminal device reporting two CRIs or SSBRIs, two L1-RSRPs or L1-SINRs, two terminal device capability values and one panel offset value, thereby improving the applicability of the beam measurement reporting method to support multi-panel simultaneous transmission scenarios.

Based on any one of the aforementioned embodiments of the present application, this embodiment further discloses a processing method.

Optionally, a group-based beam reporting parameter (e.g., groupBasedBeamReporting-r18) is added to the channel state information reporting configuration information element (e.g., CSI-ReportConfig). The group-based beam reporting parameter is set to enabled, indicating that the terminal device reports the beam measurement information using the group-based beam reporting method.

Optionally, if the reporting quantity parameter (e.g., reportQuantity) is set to CRI and RSRP index value (e.g., cri-RSRP-Index) or SSB index value and RSRP index value (e.g., ssb-Index-RSRP-Index), in one CSI report, several groups of beam measurement results are included, and one bit is used to indicate the channel state information resource set corresponding to the channel measurement resource corresponding to the largest L1-RSRP. The order of the channel state information resource sets corresponding to the two channel measurement resources in other groups is the same as the order of the channel state information resource sets in the group containing the largest L1-RSRP. For each group of beam measurement results, the terminal device reports two CRIs or SSBRIs, two L1-RSRPs and two panel index values, as shown in Table 8.

TABLE 8
Fifth example of beam information reporting

| Channel state information | | | |
|---|---|---|---|
| resource set ID with the | | Channel measurement | Channel measurement |
| largest L1-RSRP | group ID | resource ID in set #0 | resource ID in set #1 |
| Channel state information | group ID#0 | Panel index value m | Panel index value n |
| resource set ID#0 | | SSBRI/CRI#i, | SSBRI/CRI#i + 3, |
| | | L1-RSRP(7 bit) | L1-RSRP(4 bit) |
| | group ID#1 | Panel index value m | Panel index value n |
| | | SSBRI/CRI#i + 2, | SSBRI/CRI#i + 8, |
| | | L1-RSRP(4 bit) | L1-RSRP(4 bit) |
| | group ID#2 | Panel index value m | Panel index value n |
| | | SSBRI/CRI#i + 5, | SSBRI/CRI#i + 10, |
| | | L1-RSRP(4 bit) | L1-RSRP(4 bit) |

Optionally, a group of CRI or SSBRI, L1-RSRP, and panel index value corresponds to the channel measurement resource in one channel state information resource set. The panel index value is determined by the panel receiving the channel measurement resource. An example of the order of each CSI field in one CSI report is shown in Table 9.

TABLE 9
Fourth Example of the Order of Each CSI Field in one CSI Report reporting

| CSI reporting | |
|---|---|
| number | CSI field |
| CSI reporting #n | Channel state information resource set ID |
| | First SSBRI/CRI of group ID#0, optional reporting |
| | Second SSBRI/CRI of group ID#0, optional reporting |
| | First SSBRI/CRI of group ID#1, optional reporting |
| | Second SSBRI/CRI of group ID#1, optional reporting |
| | First SSBRI/CRI of group ID#2, optional reporting |
| | Second SSBRI/CRI of group ID#2, optional reporting |
| | First SSBRI/CRI of group ID#3, optional reporting |
| | Second SSBRI/CRI of group ID#3, optional reporting |
| | RSRP corresponding to the first SSBRI/CRI of group ID#0 |
| | Differential RSRP corresponding to the second SSBRI/CRI of |
| | group ID#0 |
| | Differential RSRP corresponding to the first SSBRI/CRI of group |
| | ID#1, optional reporting |
| | Differential RSRP corresponding to the second SSBRI/CRI of |
| | group ID#1, optional reporting |
| | Differential RSRP corresponding to the first SSBRI/CRI of group |
| | ID#2, optional reporting |
| | Differential RSRP corresponding to the second SSBRI/CRI of |
| | group ID#2, optional reporting |
| | Differential RSRP corresponding to the first SSBRI/CRI of group |
| | ID#3, optional reporting |
| | Differential RSRP corresponding to the second SSBRI/CRI of |
| | group ID#3, optional reporting |
| | Panel index value corresponding to the first SSBRI/CRI of group |
| | ID#0, optional reporting |
| | Panel index value corresponding to the second SSBRI/CRI of |
| | group ID#0, optional reporting |
| | Panel index value corresponding to the first SSBRI/CRI of group |
| | ID#1, optional reporting |
| | Panel index value corresponding to the second SSBRI/CRI of |
| | group ID#1, optional reporting |
| | Panel index value corresponding to the first SSBRI/CRI of group |
| | ID#2, optional reporting |
| | Panel index value corresponding to the second SSBRI/CRI of |
| | group ID#2, optional reporting |
| | Panel index value corresponding to the first SSBRI/CRI of group |
| | ID#3, optional reporting |
| | Panel index value corresponding to the second SSBRI/CRI of |
| | group ID#3, optional reporting |

Optionally, if the reporting quantity parameter (e.g., reportQuantity) is set to CRI and SINR index value (e.g., cri-SINR-Index) or SSB index value and SINR index value (e.g., ssb-Index-SINR-Index), in one CSI report, several groups of beam measurement results are included. For each group of beam measurement results, the terminal device reports two CRIs or SSBRIs, two L1-SINRs, and two panel index values. Optionally, a group of CRI or SSBRI, L1-SINR, and panel index value corresponds to the channel measurement resource in one channel state information resource set, and the panel index value is determined by the panel that receives the channel measurement resource.

This embodiment, through the above-described solution, provides a method for reporting the beam measurement information including two panel index values. This method involves a terminal device reporting two CRIs or SSBRIs, two L1-RSRPs or L1-SINRs, and two panel index values, improving the applicability of beam measurement reporting to support scenarios where multi-panel simultaneously transmission scenes.

Based on any of the above-mentioned embodiments of the present application, this embodiment further discloses a processing method. Referring to FIG. 7, FIG. 7 is a flowchart illustrating the processing method according to an embodiment. The processing method further includes:
determining a transmission mode of the PUSCH based on RRC signaling and/or DCI.

Optionally, the RRC signaling includes at least one of a PUSCH transmission scheme parameter, a PUSCH spatial division multiplexing single frequency network scheme parameter, a PUSCH single frequency network scheme parameter, and a PUSCH allocation list parameter.

Optionally, for a single-DCI based multi-TRP scenario, the PUSCH transmission mode can include at least one of the following: time division multiplexing (TDM), spatial division multiplexing (SDM), and single frequency network (single frequency network). Optionally, multi-panel uplink simultaneous transmission can be performed based on spatial division multiplexing and single frequency network. Since there are multiple PUSCH transmission modes, the network device needs to indicate the PUSCH transmission mode to the terminal device.

Optionally, determining a PUSCH transmission mode based on RRC signaling and/or DCI includes at least one of the following:
if the RRC signaling and/or DCI satisfies a first condition, performing the PUSCH transmission using spatial division multiplexing;
if the RRC signaling and/or DCI satisfies a second condition, performing the PUSCH transmission using a single frequency network; and
if the RRC signaling satisfies a third condition, performing the PUSCH transmission using time division multiplexing.

Optionally, satisfying the first condition includes at least one of the following:
the PUSCH transmission scheme parameter is set to spatial division multiplexing;
the PUSCH spatial division multiplexing single frequency network scheme parameter is set to spatial division multiplexing;
the PUSCH allocation list parameter is not configured with a repetition number parameter, and the PUSCH single frequency network scheme parameter is not configured. The DCI indicates two TCI states; and the antenna port field in the DCI indicates that the DMRS ports are included in two code division multiplexing groups.

Optionally, satisfying the second condition includes at least one of the following:
the PUSCH transmission scheme parameter is set to single frequency network;
the PUSCH spatial division multiplexing single frequency network scheme parameter is set to single frequency network;
the PUSCH single frequency network scheme parameter is set to enabled; and
the PUSCH allocation list parameter is not configured with a repetition number parameter; the DCI indicates two TCI states; and the antenna port field in the DCI indicates that the DMRS ports are included in one code division multiplexing group.

Optionally, satisfying the third condition includes the PUSCH transmission scheme parameter being set to time division multiplexing.

Optionally, the network device adds a PUSCH transmission scheme parameter (for example, puschTxScheme-r18) in the RRC. When this parameter is set to time division multiplexing, spatial division multiplexing, or single frequency network, it indicates that PUSCH transmission uses time division multiplexing, spatial division multiplexing, or single frequency network, respectively.

Optionally, the network device adds a PUSCH spatial division multiplexing and single frequency network scheme parameter (for example, sdmSfnSchemePUSCH-r18) in the RRC. When this parameter is set to spatial division multiplexing or single frequency network, it indicates that PUSCH transmission uses spatial division multiplexing or single frequency network, respectively.

Optionally, the network device adds a PUSCH single-frequency network scheme parameter (for example, sfnSchemePUSCH-r18) in the RRC. When this parameter is set to enabled, it indicates that the PUSCH transmission uses the single frequency network scheme. When the PUSCH allocation list parameter (for example, puschAllocationList) is not configured with the repetition number parameter, the terminal device is not configured with the PUSCH single-frequency network scheme parameter, the DCI indicates two uplink TCI states or joint TCI states, and the antenna port field in the DCI indicates that the DMRS ports are included in two code division multiplexing groups, it indicates that the PUSCH transmission uses the spatial division multiplexing scheme.

Optionally, when the PUSCH allocation list parameter (for example, puschAllocationList) is not configured with the repetition number parameter, the DCI indicates two uplink TCI states or joint TCI states, and the antenna port field in the DCI indicates that the DMRS ports are included in two code division multiplexing groups, it indicates that the PUSCH transmission uses the spatial division multiplexing scheme. When the PUSCH allocation list parameter (for example, puschAllocationList) is not configured with the repetition number parameter, the DCI indicates two uplink TCI states or joint TCI states, and the antenna port field in the DCI indicates that the DMRS ports are included in one code division multiplexing group, it indicates that the PUSCH transmission uses a single frequency network scheme.

This embodiment, through the above mentioned solution, specifically includes determining the transmission mode of the PUSCH based on RRC signaling and/or DCI. By adding the parameter in the RRC signaling and/or DCI, multiple methods for determining the PUSCH transmission mode are provided.

Based on any of the above embodiments of the present application, this embodiment further discloses a processing method.

Optionally, the network device adds a PUSCH transmission scheme parameter (e.g., puschTxScheme-r18) in the RRC. This parameter is an enumerated type with three possible values, corresponding to PUSCH transmission modes of time division multiplexing, spatial division multiplexing and single frequency network. Namely, when the PUSCH transmission scheme parameter is set to time division multiplexing (e.g., tdm), PUSCH transmission uses time division multiplexing; when the PUSCH transmission scheme parameter is set to spatial division multiplexing (e.g., sdm), PUSCH transmission uses spatial division multiplexing; and when the PUSCH transmission scheme parameter is set to single frequency network (e.g., sfn), PUSCH transmission uses single frequency network.

Optionally, as one of the methods for adding parameter, the PUSCH transmission scheme parameter is added in the PUSCH configuration information element (e.g., PUSCH-Config), for example:

```
  PUSCH-Config ::= SEQUENCE {
  [...]
```

| | |
|---|---|
| pusch-RepTypeIndicatorDCI-0-1-r16 | ENUMERATED { pusch-RepTypeA, pusch- |

RepTypeB} OPTIONAL, -- Need R

| | |
|---|---|
| puschScheme-r18 | ENUMERATED {tdm, sdm, sfn} |

```
OPTIONAL -- Need R
  [...]
  }
```

Optionally, as another method for adding parameter, the PUSCH transmission scheme parameter is added in the MIMO parameter information element (e.g., MIMOParam-r17), for example:

```
  MIMOParam-r17 ::= SEQUENCE {
  [...]
```

| | | |
|---|---|---|
| sfnSchemePDCCH-r17 | ENUMERATED {sfnSchemeA,sfnSchemeB} | OPTIONAL, -- Need |

R

| | | |
|---|---|---|
| sfnSchemePDSCH-r17 | ENUMERATED {sfnSchemeA,sfnSchemeB} | OPTIONAL -- Need |

R

| | | |
|---|---|---|
| puschScheme-r18 | ENUMERATED {tdm, sdm, sfn} | OPTIONAL -- Need |

R
}

Optionally, if RRC is configured with at least one of the following parameters: a repetition number parameter (e.g., numberOfRepetitions), a PUSCH aggregation factor parameter (e.g., pusch-AggregationFactor), a multi-slot TB processing slot number parameter (e.g., numberOfSlotsTBoMS), a DCI 0-1 scheduling PUSCH repetition type indication parameter (e.g., pusch-RepTypeIndicatorDCI-0-1), and a DCI 0-2 scheduling PUSCH repetition type indication parameter (e.g., pusch-RepTypeIndicatorDCI-0-2), it indicates that PUSCH transmission uses time division multiplexing.

Optionally, a PUSCH spatial division multiplexing single frequency network scheme parameter (for example: sdmSfnSchemePUSCH-r18) is added in RRC. This parameter is an enumerated type with two possible values, corresponding to the PUSCH transmission modes of spatial division multiplexing and single frequency network. Namely, when the PUSCH spatial division multiplexing single frequency network scheme parameter is set to spatial division multiplexing (for example: sdm), it indicates that PUSCH transmission uses the spatial division multiplexing scheme; when the PUSCH spatial division multiplexing single frequency network scheme parameter is set to single frequency network (for example: sfn), it indicates that PUSCH transmission uses the single frequency network scheme.

Optionally, as one of the methods for adding parameter, the PUSCH spatial division multiplexing single frequency network scheme parameter is added in the PUSCH configuration information element (e.g., PUSCH-Config), for example:

```
  PUSCH-Config ::= SEQUENCE {
  [...]
```

| | |
|---|---|
| pusch-RepTypeIndicatorDCI-0-1-r16 | ENUMERATED { pusch-RepTypeA, pusch- |

RepTypeB} OPTIONAL, -- Need R

| | |
|---|---|
| sdmSfnSchemePUSCH-r18 | ENUMERATED {sdm, sfn} OPTIONAL |

```
-- Need R
  [...]
  }
```

Optionally, as another method for adding parameter, the PUSCH spatial division multiplexing single frequency network scheme parameter is added in the MIMO parameter information element (e.g., MIMOParam-r17), for example:

```
  MIMOParam-r17 ::= SEQUENCE {
  [...]
```

| | | |
|---|---|---|
| sfnSchemePDCCH-r17 | ENUMERATED {sfnSchemeA,sfnSchemeB} | OPTIONAL, -- |

Need R

| | | |
|---|---|---|
| sfnSchemePDSCH-r17 | ENUMERATED {sfnSchemeA,sfnSchemeB} | OPTIONAL -- |

Need R

| | | |
|---|---|---|
| sdmSfnSchemePUSCH-r18 | ENUMERATED {sdm, sfn} | OPTIONAL -- Need |

R
}

Optionally, a PUSCH single-frequency network scheme parameter (e.g., sfnSchemePUSCH-r18) is added in the RRC. When the PUSCH single-frequency network scheme parameter is set to enabled (e.g., enabled), PUSCH transmission uses a single-frequency network scheme.

Optionally, the PUSCH single-frequency network scheme parameter can be added in the PUSCH configuration information element (e.g., PUSCH-Config), for example:

```
  PUSCH-Config ::= SEQUENCE {
  [...]
```

| | |
|---|---|
| pusch-RepTypeIndicatorDCI-0-1-r16 | ENUMERATED { pusch-RepTypeA, pusch- |

RepTypeB} OPTIONAL, -- Need R

| | |
|---|---|
| sfnSchemePUSCH-r18 | ENUMERATED {enabled} OPTIONAL |

```
-- Need R
  [...]
  }
```

Optionally, the PUSCH single frequency network scheme parameter may be added in the MIMO parameter information element (e.g., MIMOParam-r17), for example:

```
  MIMOParam-r17 ::= SEQUENCE {
  [...]
```

| | | |
|---|---|---|
| sfnSchemePDCCH-r17 | ENUMERATED {sfnSchemeA,sfnSchemeB} | OPTIONAL, -- |

Need R

| | | |
|---|---|---|
| sfnSchemePDSCH-r17 | ENUMERATED {sfnSchemeA,sfnSchemeB} | OPTIONAL -- |

Need R

| | | |
|---|---|---|
| sfnSchemePUSCH-r18 | ENUMERATED {enabled} | OPTIONAL -- |

Need R
}

Optionally, if all of the following conditions are satisfied, PUSCH transmission uses spatial division multiplexing:
1) the PUSCH allocation list parameter (e.g., puschAllocationList) contained in the PUSCH time domain resource allocation parameter indicated by time domain resource assignment field in the DCI is not configured with a repetition number parameter (e.g., numberOfRepetitions);
2) the PUSCH single-frequency network scheme parameter is not configured or is set to disabled;
3) the DCI indicates two transmission configuration indicator (TCI) states for uplink transmission. Optionally, the TCI state can be a joint TCI state (e.g., TCI-State) in joint mode or an uplink TCI state (e.g., TCI-UL-State) in separate mode;
4) the antenna port field (e.g., Antenna Ports) in the DCI indicates that the DMRS (DMRS) ports are included in two code division multiplexing (CDM) groups.

Optionally, a PUSCH spatial multiplexing scheme parameter (e.g., sdmSchemePUSCH-r18) is added in the RRC. When the PUSCH spatial multiplexing scheme parameter is set to enabled (e.g., enabled), it indicates that PUSCH transmission uses spatial multiplexing.

Optionally, the PUSCH spatial multiplexing scheme parameter is added in the PUSCH configuration information element (e.g., PUSCH-Config) or in the MIMO parameter information element (e.g., MIMOParam-r17). If all of the following conditions are satisfied, it indicates that the PUSCH transmission uses single-frequency network:
1) the PUSCH allocation list parameter (e.g., puschAllocationList) contained in the PUSCH time domain resource allocation parameter indicated by time domain resource assignment field in the DCI is not configured with a repetition number parameter (e.g., numberOfRepetitions);
2) the PUSCH spatial multiplexing scheme parameter is not configured or is set to disabled;
3) the DCI indicates two TCI states for uplink transmission. Optionally, the TCI state can be either the joint TCI state in joint mode or the uplink TCI state (e.g., TCI-UL-State) in a separate mode; and
4) the antenna port field in the DCI indicates that the DMRS ports are included in one CDM group.

Optionally, a PUSCH spatial multiplexing scheme parameter (e.g., sdmSchemePUSCH-r18) is added in the RRC. When the PUSCH spatial multiplexing scheme parameter is set to enabled (e.g., enabled), it indicates that PUSCH transmission uses spatial multiplexing.

Optionally, the PUSCH spatial multiplexing scheme parameter can be added in the PUSCH configuration information element (e.g., PUSCH-Config) or the MIMO parameter information element (e.g., MIMOParam-r17).

Optionally, a PUSCH single-frequency network scheme parameter (e.g., sfnSchemePUSCH-r18) is added in the RRC. When the PUSCH single-frequency network scheme parameter is set to enabled, PUSCH transmission uses the single-frequency network scheme.

Optionally, the PUSCH single-frequency network scheme parameter can be added in the PUSCH configuration information element (e.g., PUSCH-Config) or the MIMO parameter information element (e.g., MIMOParam-r17).

Optionally, if all of the following conditions are satisfied, PUSCH transmission uses spatial division multiplexing:
1) the PUSCH allocation list parameter (e.g., puschAllocationList) contained in the PUSCH time domain resource allocation parameter indicated by the time domain resource assignment field in the DCI is not configured with the repetition number parameter (e.g., numberOfRepetitions).
2) the DCI indicates two TCI states for uplink transmission. Optionally, the TCI state can be either a joint TCI state in joint mode or an uplink TCI state (e.g., TCI-UL-State) in separate mode; and
3) the antenna port field (e.g., Antenna ports) in the DCI indicates that the DMRS ports are included in two CDM groups.

Optionally, if all of the following conditions are satisfied, PUSCH transmission uses a single-frequency network:
1) the PUSCH allocation list parameter (e.g., puschAllocationList) contained in the PUSCH time domain resource allocation parameter indicated by the time domain resource assignment field in the DCI is not configured with a repetition number parameter (e.g., numberOfRepetitions);
2) the DCI indicates two TCI states for uplink transmission. Optionally, the TCI state can be a joint TCI state in joint mode or an uplink TCI state (e.g., TCI-UL-State) in separate mode; and
3) the antenna port field (e.g., Antenna Ports) in the DCI indicates that the DMRS ports are included in one CDM group.

This embodiment, through the above mentioned solution, specifically includes determining the transmission mode of the PUSCH based on the radio resource control signaling and/or DCI, and providing a method for determining that the PUSCH transmission mode is at least one of the spatial division multiplexing scheme, the single frequency network scheme and the time division multiplexing scheme by adding parameters in the radio resource control signaling and/or the DCI, thereby flexibly indicating a clear transmission mode for PUSCH to the terminal device, so that the terminal device can use the corresponding TCI state and PUSCH association method.

Based on any of the above-mentioned embodiments of the present application, this embodiment discloses a specific method for step S2. Referring to FIG. 8, FIG. 8 is a flowchart illustrating the processing method according to an embodiment, the step S2 includes the following steps:
S21, based on the TCI state(s) indicated by the value of the SRS resource set indicator field in the DCI, providing reference signal(s) for the corresponding PUSCH; and
S22, determining uplink transmission spatial filter based on the reference signal.

Optionally, for simultaneous PUSCH transmission on multiple panels, if the terminal device selects two panels to use spatial division multiplexing or single frequency network for PUSCH transmission, the terminal device uses the transmission configuration indicator (TCI) state associated with the panel for PUSCH transmission. The network device indicates two uplink TCI states (e.g., TCI-UL-State) or joint TCI states (e.g., TCI-State) through the TCI state activation/deactivation MAC CE (e.g., Unified TCI States Activation/Deactivation MAC CE) and/or the TCI field in the DCI (e.g., Transmission configuration indication), and indicates the TCI state associated with the panel through the SRS resource set indicator field in the DCI. The terminal device uses the TCI state associated with the panel for simultaneous PUSCH transmission on multiple panels. For simultaneous transmission of multi-panel PUSCHs in single DCI based multi-network device scenario, the PUSCH transmission method can optionally include spatial division multiplexing and/or single frequency network. Optionally, the PUSCH is a PUSCH transmission dynamically scheduled by DCI and/or a configured grant type 2 PUSCH transmission. Optionally, the multi-network device can be multi-transmission/reception point (Multi-TRP).

Optionally, providing the reference signal(s) for the corresponding PUSCH based on TCI state(s) indicated by a value of SRS resource set indicator field in the DCI includes at least one of the following:
the value of the SRS resource set indicator field is a first value or a second value, the first TCI state provides a reference signal for a PUSCH associated with a terminal device capability value corresponding to the first TCI state, and the second TCI state provides a reference signal for a PUSCH associated with a terminal device capability value corresponding to the second TCI state;
the value of the SRS resource set indicator field is a first value, the first TCI state provides the reference signal for the PUSCH associated with the first terminal device capability value, while the second TCI state provides the reference signal for the PUSCH associated with the second terminal device capability value;
the value of the SRS resource set indicator field is a second value, the first TCI state provides the reference signal for the PUSCH associated with the second terminal device capability value, and the second TCI state provides the reference signal for the PUSCH associated with the first terminal device capability value;
the value of the SRS resource set indicator field is a first value, the first TCI state provides the reference signal for the PUSCH associated with the first panel index value, and the second TCI state provides the reference signal for the PUSCH associated with the second panel index value;
the value of the SRS resource set indicator field is a second value, the first TCI state provides the reference signal for the PUSCH associated with the second panel index value, and the second TCI state provides the reference signal for the PUSCH associated with the first panel index value.

If multi-panel PUSCHs are simultaneously transmitted using spatial division multiplexing, the value of SRS resource set indicator field is the first value or the second value, the first TCI state is associated with the first group of antenna ports, and the second TCI state is associated with the second group of antenna ports.

If multiple-panel PUSCHs are simultaneously transmitted using spatial division multiplexing, the value of SRS resource set indicator field is the first value or the second value, the first TCI state provides the reference signal for the first PUSCH, and the second TCI state provides the reference signal for the second PUSCH.

If multi-panel PUSCHs are simultaneously transmitted using a single frequency network, the value of SRS resource set indicator field is the first value or the second value, and the first TCI state and the second TCI state provide reference signals for the PUSCH.

Optionally, in the embodiment of the present application, the first value is “10” and the second value is “11”, the first terminal device capability value is a smaller terminal device capability value, and the second terminal device capability value is a larger terminal device capability value. Optionally, the smaller terminal device capability value may be a smaller terminal device capability value or a smaller terminal device capability value index value, and/or the larger terminal device capability value may be a larger terminal device capability value or a larger terminal device capability value index value.

Optionally, the TCI state in the embodiment of the present application is an uplink TCI state or a joint TCI state, that is, an uplink TCI state (for example, TCI-UL-State) in a separate mode, or a joint TCI state in a joint mode.

Optionally, the value of SRS resource set indicator field in DCI format 0_1 or 0_2 is “10” or “11”, and the first uplink TCI state or joint TCI state is applied to the PUSCH transmission associated with the terminal device capability value corresponding to the TCI state, that is: the first uplink TCI state or joint TCI state provides the reference signal for the PUSCH associated with the terminal device capability value corresponding to the TCI state to determine the uplink transmission spatial filter; the second uplink TCI state or joint TCI state is applied to the PUSCH transmission associated with the terminal device capability value corresponding to the TCI state, that is: the second uplink TCI state or joint TCI state provides the reference signal for the PUSCH associated with the terminal device capability value corresponding to the TCI state to determine the uplink transmission spatial filter.

Optionally, the value of SRS resource set indicator field in DCI format 0_1 or 0_2 is “10” or “11”, and the first uplink TCI state or joint TCI state is applied to the PUSCH transmission of the terminal device panel corresponding to the TCI state, that is, the first uplink TCI state or joint TCI state provides the reference signal for the PUSCH of the terminal device panel corresponding to the TCI state to determine the uplink transmission spatial filter; the second uplink TCI state or joint TCI state is applied to the PUSCH transmission of the terminal device panel corresponding to the TCI state, that is, the second uplink TCI state or joint TCI state provides the reference signal for the PUSCH of the terminal device panel corresponding to the TCI state to determine the uplink transmission spatial filter.

Optionally, the value of SRS resource set indicator field value in DCI format 0_1 or 0_2 is “10”, the first uplink TCI state or joint TCI state provides the reference signal for the PUSCH associated with a smaller terminal device capability value to determine the uplink transmission spatial filter, and the second uplink TCI state or joint TCI state provides the reference signal for the PUSCH associated with a larger terminal device capability value to determine the uplink transmission spatial filter. The value of SRS resource set indicator field in DCI format 0_1 or 0_2 is “11”, the first uplink TCI state or joint TCI state provides the reference signal for the PUSCH associated with the larger terminal device capability value to determine the uplink transmission spatial filter, and the second uplink TCI state or joint TCI state provides the reference signal for the PUSCH associated with the smaller terminal device capability value to determine the uplink transmission spatial filter.

Optionally, the value of SRS resource set indicator field in DCI format 0_1 or 0_2 is “10”, the first uplink TCI state or joint TCI state provides the reference signal for the PUSCH associated with a smaller panel index value to determine the uplink transmission spatial filter, and the second uplink TCI state or joint TCI state provides the reference signal for the PUSCH associated with a larger panel index value to determine the uplink transmission spatial filter. The value of SRS resource set indicator field in DCI format 0_1 or 0_2 is “11”, the first uplink TCI state or joint TCI state provides the reference signal for the PUSCH associated with the larger panel index value to determine the uplink transmission spatial filter, and the second uplink TCI state or joint TCI state provides the reference signal for the PUSCH associated with the smaller panel index value to determine the uplink transmission spatial filter. Optionally, the panel index value can be the index value of the panel entity or the temporary index value of the panel.

Optionally, for simultaneous transmission of multi-panel PUSCH in single DCI based multi-transmission/reception point scenario, the PUSCH transmission mode may include at least one of the following: spatial division multiplexing and single frequency network. The network device indicates two uplink TCI states or joint TCI states by activating/deactivating MAC CE and/or TCI field in DCI. The terminal device needs to apply these two TCI states to the corresponding PUSCH respectively. For the association between TCI state and PUSCH:

Optionally, if simultaneous PUSCH transmission on multiple panels uses the spatial division multiplexing, and the value of SRS resource set indicator field in DCI format 0_1 or 0_2 is “10” or “11”, the first uplink TCI state or joint TCI state is associated with the code division multiplexing (CDM) group corresponding to the first antenna port indicated by the antenna port field (for example, Antenna ports) in the DCI, that is, the first uplink TCI state or joint TCI state provides the reference signal for the PUSCH associated with the CDM group to determine the uplink transmission spatial filter; the second uplink TCI state or joint TCI state is associated with other CDM groups, that is, the second uplink TCI state or joint TCI state provides the reference signal for the PUSCH associated with the CDM group to determine the uplink transmission spatial filter.

Optionally, if simultaneous PUSCH transmission on multiple panels uses the spatial division multiplexing, and the value of SRS resource set indicator field in DCI format 0_1 or 0_2 is “10” or “11”, the first uplink TCI state or joint TCI state is associated with a first group of antenna ports, and the second uplink TCI state or joint TCI state is associated with a second group of antenna ports. Optionally, the first group of antenna ports are the antenna ports included in the first code division multiplexing (CDM) group indicated by the antenna port field (e.g., Antenna ports) in DCI format 0_1 or 0_2, and the second group of antenna ports are the antenna ports included in the second CDM group. Optionally, the first group of antenna ports are the antenna ports included in the code division multiplexing group corresponding to the first antenna port indicated by the antenna port field in DCI format 0_1 or 0_2, and the second group of antenna ports are the antenna ports included in other CDM groups. Optionally, the first group of antenna ports are the first L1 antenna ports corresponding to the L1 layers indicated by the first precoding information and number of layers field (e.g., Precoding information and number of layers) or the first SRS resource indicator field (e.g., SRS resource indicator) in DCI format 0_1 or 0_2, and the second group of antenna ports are the remaining L2 antenna ports corresponding to the L2 layers indicated by the second precoding information field (e.g., precoding information and number of layers or second precoding information) or the second SRS resource indicator field (e.g., SRS resource indicator or second SRS resource indicator) in DCI format 0_1 or 0_2, where L1 and L2 are integers. Optionally, the first group of antenna ports are the L1 antenna ports corresponding to the L1 layers indicated by the first precoding information and number of layers field or the first SRS resource indicator field in DCI format 0_1 or 0_2. The second group of antenna ports are the L2 antenna ports corresponding to the L2 layers indicated by the second precoding information field (e.g., precoding information and number of layers or Second Precoding information) or the second SRS resource indicator field (e.g., SRS resource indicator or Second SRS resource indicator) in DCI format 0_1 or 0_2, where L1 and L2 are integers. Optionally, the antenna port is a DMRS port. Optionally, the antenna port is a PUSCH antenna port.

Optionally, if simultaneous PUSCH transmission on multiple panels uses the spatial division multiplexing, and the value of SRS resource set indicator field in DCI format 0_1 or 0_2 is “10” or “11”, the first uplink TCI state or joint TCI state provides the reference signal for the first PUSCH to determine the uplink transmission spatial filter, and the second uplink TCI state or joint TCI state provides the reference signal for the second PUSCH to determine the uplink transmission spatial filter. Optionally, the first PUSCH includes the L1 layers indicated by the first precoding information and number of layers field (e.g., Precoding information and number of layers) or the first SRS resource indicator field (e.g., SRS resource indicator) in DCI format 0_1 or 0_2; and the second PUSCH includes the L2 layers indicated by the second precoding information field (e.g., precoding information and number of layers or second precoding information) or the second SRS resource indicator field (e.g., SRS resource indicator or second SRS resource indicator) in DCI format 0_1 or 0_2, where L1 and L2 are integers.

Optionally, if simultaneous PUSCH transmission on multiple panels uses the single frequency network, and the value of SRS resource set indicator field in DCI format 0_1 or 0_2 is “10” or “11”, the first and second uplink TCI states or joint TCI states provide the reference signal for the PUSCH to determine the uplink transmission spatial filter.

This embodiment, through the above solution, specifically provides reference signal(s) for the corresponding PUSCH by indicating the transmission configuration indicator states based on the value of the SRS resource set indicator field in the DCI; determines the uplink transmission spatial filter based on the reference signal(s), and provides a method for associating the TCI state with the PUSCH, which is applicable to transmission in spatial division multiplexing and single frequency network scheme.

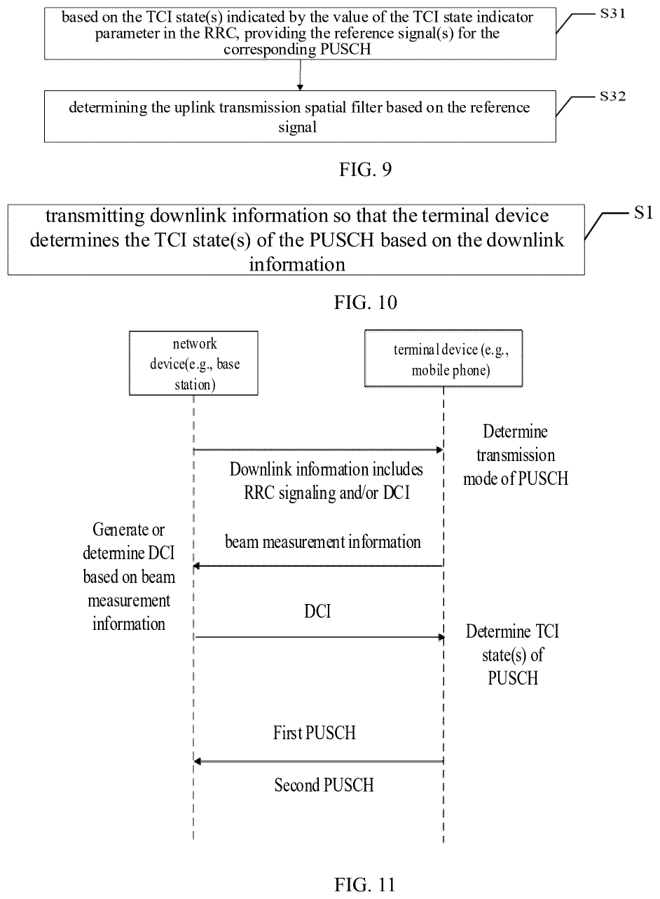

Based on any of the above-mentioned embodiments of the present application, this embodiment discloses a specific method for step S3. Referring to FIG. 9, FIG. 9 is a flow chart illustrating a processing method according to an embodiment, showing that the step S3 includes the following steps:
S31, based on the TCI state(s) indicated by the value of the TCI state indicator parameter in the RRC, providing the reference signal(s) for the corresponding PUSCH; and
S32, determining the uplink transmission spatial filter based on the reference signal.

Optionally, for simultaneous transmission of multi-panel PUSCH, if the terminal device selects two panels to use spatial division multiplexing or single frequency network scheme for PUSCH transmission, the terminal device uses the TCI state(s) associated with the PUSCH for PUSCH transmission. The network device indicates two uplink TCI states (e.g., TCI-UL-State) or joint TCI states (e.g., TCI-State) through TCI state activation/deactivation MAC CE and/or TCI field in DCI, and indicates the TCI state(s) associated with the PUSCH through the TCI state indicator parameter in the RRC. The terminal device uses the TCI state associated with the PUSCH for simultaneous transmission of multi-panel PUSCH. For simultaneous transmission of the multi-panel PUSCH in single DCI based multi-network device scenario, the PUSCH transmission method can optionally include spatial division multiplexing and/or single frequency network. Optionally, the PUSCH is configured grant type 1 (e.g., configured grant Type 1) PUSCH transmission. Optionally, the multi-network device can be multi-transmission/reception point (Multi-TRP).

Optionally, TCI state indicator parameter (e.g., TCIStateIndicator) is added in the configuration grant configuration information element (e.g., configuredGrantConfig). This parameter indicates that the TCI state(s) used for PUSCH transmission includes at least one of the following: the first TCI state, the second TCI state, the first and second TCI states.

Optionally, providing the reference signal(s) for the corresponding PUSCH based on the TCI state(s) indicated by a value of TCI state indicator parameter in the RRC includes at least one of the following:
if simultaneous transmission of the multi-panel PUSCH uses the spatial division multiplexing scheme, the TCI state indicator parameter indicates that the TCI states used for PUSCH transmission are the first and second TCI states, the first TCI state is associated with the first group of antenna ports, and the second TCI state is associated with the second group of antenna ports;
if simultaneous transmission of the multi-panel PUSCH uses the spatial division multiplexing manner, the TCI state indicator parameter indicates that the TCI states used for PUSCH transmission are the first and second TCI states, the first TCI state provides the reference signal for the first PUSCH, and the second TCI state provides a reference signal for the second PUSCH;
if simultaneous transmission of the multi-panel PUSCH uses the single frequency network scheme, the TCI state indicator parameter indicates that the TCI states used for PUSCH transmission are the first and second TCI states, and the first TCI state and the second TCI state provide reference signals for the PUSCH.

Optionally, the TCI state in the embodiment of the present application is an uplink TCI state or a joint TCI state, that is, an uplink TCI state (for example, TCI-UL-State) in a separate mode, or a joint TCI state in a joint mode.

Optionally, if simultaneous transmission of the multi-panel PUSCH uses the spatial division multiplexing scheme, and the TCI state indicator parameter indicates that the TCI states used for PUSCH transmission are the first and second uplink TCI states or joint TCI states, the first uplink TCI state or joint TCI state is associated with the first group of antenna ports, and the second uplink TCI state or joint TCI state is associated with the second group of antenna ports.

Optionally, the first group of antenna ports are the first L1 antenna ports corresponding to the L1 layers indicated by the first precoding and number of layers parameter (e.g., precodingAndNumberOfLayers) or the first SRS resource indicator parameter (e.g., srs-ResourceIndicator) in the configuration grant configuration information element, and the second group of antenna ports are the remaining L2 antenna ports corresponding to the L2 layers indicated by the second precoding and number of layers parameter (e.g., precodingAndNumberOfLayers2) or the second SRS resource indicator field (e.g., srs-ResourceIndicator2) in the configuration grant configuration information element, where L1 and L2 are integers. Optionally, the first group of antenna ports are the L1 antenna ports corresponding to the L1 layers indicated by the first precoding and number of layers parameter (e.g., precodingAndNumberOfLayers) or the first SRS resource indicator parameter (e.g., srs-ResourceIndicator) in the configuration grant configuration information element. The second group of antenna ports are the L2 antenna ports corresponding to the L2 layers indicated by the second precoding and number of layers parameter (e.g., precodingAndNumberOfLayers2) or the second SRS resource indicator field (e.g., srs-ResourceIndicator2) in the configuration grant configuration information element, where L1 and L2 are integers. Optionally, the antenna ports are DMRS ports. Optionally, the antenna ports are PUSCH antenna ports.

Optionally, if simultaneous transmission of the multi-panel PUSCH uses the spatial division multiplexing, and the TCI state indicator parameter indicates that the TCI states used for PUSCH transmission are the first and second uplink TCI states or the joint TCI state, the first uplink TCI state or the joint TCI state provides the reference signal for the first PUSCH to determine the uplink transmission spatial filter, and the second uplink TCI state or the joint TCI state provides the reference signal for the second PUSCH to determine the uplink transmission spatial filter. Optionally, the first PUSCH includes the L1 layers indicated by the first precoding and number of layers parameter (e.g., precodingAndNumberOfLayers) or the first SRS resource indication parameter (e.g., srs-ResourceIndicator) in the configuration grant configuration information element. The second PUSCH includes the L2 layers indicated by the second precoding and number of layers parameter (e.g., precodingAndNumberOfLayers2) or the second SRS resource indication field (e.g., srs-ResourceIndicator2) in the configuration grant configuration information element, where L1 and L2 are integers.

Optionally, if simultaneous transmission of the multi-panel PUSCH uses the single frequency network, and the TCI state indicator parameter indicates that the TCI state used for PUSCH transmission are the first and second uplink TCI states or the joint TCI state, the first and second uplink TCI states or the joint TCI state provide the reference signals for PUSCH to determine the uplink transmission spatial filters.

This embodiment, through the above solution, specifically provides the reference signal(s) for the corresponding PUSCH by indicating the TCI state(s) based on the value of the TCI state indicator parameter in the RRC; determines the uplink transmission spatial filter(s) based on the reference signal(s), and provides a method for associating the TCI state(s) with the configuration grant type 1 PUSCH, which is applicable to transmission in spatial division multiplexing and single frequency network scheme.

Referring to FIG. 10, FIG. is a flowchart illustrating a processing method according to an embodiment. The method of this embodiment of the present application can be applied to a network device (e.g., a base station), including the following steps:
S1, transmitting downlink information, so that the terminal device determines the TCI state(s) of the PUSCH based on the downlink information.

Optionally, the downlink information includes RRC signaling and/or DCI.

Optionally, the network device generates or determines the DCI based on beam measurement information reported by the terminal device.

Optionally, the network device adds at least one of a PUSCH transmission scheme parameter, a PUSCH spatial division multiplexing single frequency network scheme parameter, and a PUSCH single frequency network scheme parameter in the RRC signaling, enabling the terminal device to determine the transmission mode of PUSCH.

Optionally, the network device transmits the RRC signaling and/or DCI, enabling the terminal device to determine the transmission mode of PUSCH based on the RRC signaling and/or DCI.

Optionally, the beam measurement information includes at least one group of beam measurement results.

Optionally, the beam measurement results include first content and/or second content.

Optionally, the first content includes at least one of the following: at least one channel state information reference signal resource indicator, at least one SSBRI, at least one L1-RSRP, and at least one L1-signal to interference plus noise ratio (L1-SINR).

Optionally, the second content includes at least one of the following: at least one terminal device capability value, at least one terminal device capability value group, at least one same panel determination value, at least one panel offset value, and at least one panel index value.

Optionally, the network device can indicate the transmission mode of PUSCH to the terminal device by adding the parameter in the RRC.

Optionally, the network device can add a PUSCH transmission scheme parameter (for example, puschTxScheme-r18) in the RRC. When this parameter is set to time division multiplexing, spatial division multiplexing, or single frequency network, it indicates that PUSCH transmission uses the time division multiplexing, the spatial division multiplexing, or single frequency network, respectively.

Optionally, the network device adds a PUSCH spatial division multiplexing single frequency network scheme parameter (for example: sdmSfnSchemePUSCH-r18) in the RRC. When the parameter is set to spatial division multiplexing and single frequency network, it indicates that PUSCH transmission uses the spatial division multiplexing and single frequency network scheme respectively.

Optionally, the network device adds the PUSCH single frequency network scheme parameter (for example, sfnSchemePUSCH-r18) in the RRC. When this parameter is set to enabled, it indicates that the PUSCH transmission uses the single frequency network scheme. When the PUSCH allocation list parameter (for example, puschAllocationList) is not configured with the repetition number parameter, the terminal device is not configured with the PUSCH single frequency network scheme parameter, the DCI indicates two uplink TCI states or joint TCI states, and the antenna port field in the DCI indicates that the DMRS ports are included in two code division multiplexing groups, it indicates that the PUSCH transmission uses the spatial division multiplexing scheme.

Optionally, when the PUSCH allocation list parameter (e.g., puschAllocationList) is not configured with the repetition number parameter, the DCI indicates two uplink TCI states or joint TCI states, and the antenna port field in the DCI indicates that the DMRS ports are included in two code division multiplexing groups, which indicates that PUSCH transmission uses the spatial division multiplexing.

Optionally, when the PUSCH allocation list parameter (e.g., puschAllocationList) is not configured with the repetition number parameter, the DCI indicates two uplink TCI states or joint TCI states, and the antenna port field in the DCI indicates that the DMRS ports are included in one code division multiplexing group, which indicates that PUSCH transmission uses the single frequency network.

Optionally, the network device indicates two uplink TCI states or joint TCI states, and the terminal device associates these two TCI states with the PUSCH.

Optionally, if the value of SRS resource set indicator field in DCI format 0_1 or 0_2 is ‘10’ or ‘11’, the first uplink TCI state or joint TCI state provides the reference signal for the PUSCH associated with the terminal device capability value corresponding to that TCI state, to determine the uplink transmission spatial filter, the second uplink TCI state or joint TCI state provides the reference signal for the PUSCH associated with the terminal device capability value corresponding to that TCI state, to determine the uplink transmission spatial filter.

Optionally, if the value of SRS resource set indicator field in DCI format 0_1 or 0_2 is ‘10’, the first uplink TCI state or joint TCI state provides the reference signal for the PUSCH associated with the smaller terminal device capability value to determine the uplink transmission spatial filter, and the second uplink TCI state or joint TCI state provides the reference signal for the PUSCH associated with the larger terminal device capability value to determine the uplink transmission spatial filter.

Optionally, if the value of SRS resource set indicator field in DCI format 0_1 or 0_2 is ‘11’, the first uplink TCI state or joint TCI state provides the reference signal for the PUSCH associated with the larger terminal device capability value to determine the uplink transmission spatial filter, and the second uplink TCI state or joint TCI state provides the reference signal for the PUSCH associated with the smaller terminal device capability value to determine the uplink transmission spatial filter.

Optionally, if the value of SRS resource set indicator field in DCI format 0_1 or 0_2 is ‘10’, the first uplink TCI state or joint TCI state provides the reference signal for the PUSCH associated with the smaller panel index value to determine the uplink transmission spatial filter, and the second uplink TCI state or joint TCI state provides the reference signal for the PUSCH associated with the larger panel index value to determine the uplink transmission spatial filter.

Optionally, if the value of SRS resource set indicator field in DCI format 0_1 or 0_2 is ‘11’, the first uplink TCI state or joint TCI state provides the reference signal for the PUSCH associated with the larger panel index value to determine the uplink transmission spatial filter, and the second uplink TCI state or joint TCI state provides the reference signal for the PUSCH associated with the smaller panel index value to determine the uplink transmission spatial filter.

Optionally, if simultaneous transmission of multi-panel PUSCH uses the single frequency network, and the value of SRS resource set indicator field in DCI format 0_1 or 0_2 is ‘10’ or ‘11’, the first and second uplink TCI states, or the joint TCI state, provide the reference signals for the PUSCH to determine the uplink transmission spatial filters.

This embodiment, through the above solution, specifically transmits the DCI, enabling the terminal device to determine the TCI state(s) of the PUSCH based on the downlink information. This method provides a method for determining the TCI state(s) of the PUSCH, applicable to transmission in both spatial division multiplexing and single frequency network scheme. This improves the applicability of beam measurement reporting in scenarios with simultaneous uplink transmission on multi-panel.

FIG. 11 is a schematic diagram of an interaction sequence according to an embodiment. Based on any of the above embodiments of the present application, this embodiment further discloses the processing methods of the above embodiments.

In an embodiment of the present application, the network device (e.g., a base station) transmits the downlink information to the terminal device (e.g., a mobile phone).

Optionally, the network device may be a first network device and/or a second network device.

Optionally, the downlink information sent by the network device includes RRC signaling and/or DCI.

Optionally, the terminal device reports beam measurement information to the network device. Optionally, the beam measurement information includes at least one group of beam measurement results.

Optionally, the terminal device reports two CRIs or SSBRIs, two L1-RSRPs or L1-SINRs, and two terminal device capability values.

Optionally, the terminal device reports two CRIs or SSBRIs, two L1-RSRPs or L1-SINRs, and two terminal device capability value groups.

Optionally, the terminal device reports two CRIs or SSBRIs, two L1-RSRPs or L1-SINRs, two terminal device capability values, and the same panel determination value.

Optionally, the terminal device reports two CRIs or SSBRIs, two L1-RSRPs or L1-SINRs, two terminal device capability values, and a panel offset value.

Optionally, the terminal device reports two CRIs or SSBRIs, two L1-RSRPs or L1-SINRs, and two panel index values.

Optionally, the network device adds at least one of a PUSCH transmission scheme parameter, a PUSCH spatial division multiplexing single frequency network scheme parameter, and a PUSCH single frequency network scheme parameter in the RRC signaling, enabling the terminal device to determine the transmission mode of PUSCH.

Optionally, the network device transmits the RRC signaling, enabling the terminal device to determine the transmission mode of PUSCH based on the RRC signaling and/or DCI.

Optionally, the network device adds a PUSCH transmission scheme parameter (e.g., puschTxScheme-r18) in the RRC signaling. When this parameter is set to time division multiplexing, spatial division multiplexing, or single frequency network, it indicates that PUSCH transmission uses TDM, SDM, or single frequency network scheme, respectively.

Optionally, the network device adds a PUSCH spatial division multiplexing single frequency network scheme parameter (for example: sdmSfnSchemePUSCH-r18) in the RRC. When the parameter is set to spatial division multiplexing and single frequency network, it indicates that PUSCH transmission uses the spatial division multiplexing and single frequency network scheme respectively.

Optionally, the network device adds a PUSCH single frequency network scheme parameter (for example, sfnSchemePUSCH-r18) in the RRC signaling. When the parameter is set to enabled, it indicates that the PUSCH transmission uses the single frequency network scheme. When the PUSCH allocation list parameter (for example, puschAllocationList) is not configured with the repetition number parameter, the terminal device is not configured with a PUSCH single-frequency network scheme parameter, the DCI indicates two uplink TCI states or joint TCI states, and the antenna port field in the DCI indicates that the DMRS ports are included in two code division multiplexing groups, it indicates that the PUSCH transmission uses the spatial division multiplexing scheme.

Optionally, when the PUSCH allocation list parameter (for example, puschAllocationList) is not configured with the repetition number parameter, the DCI indicates two uplink TCI states or joint TCI states, and the antenna port field in the DCI indicates that the DMRS ports are included in two code division multiplexing groups, it indicates that the PUSCH transmission uses the spatial division multiplexing scheme. When the PUSCH allocation list parameter (for example, puschAllocationList) is not configured with the repetition number parameter, the DCI indicates two uplink TCI states or joint TCI states, and the antenna port field in the DCI indicates that the DMRS ports are included in one code division multiplexing group, it indicates that the PUSCH transmission uses the single frequency network scheme.

Optionally, the network device indicates two uplink TCI states or joint TCI states, and the terminal device associates these two TCI states with the PUSCH.

This embodiment, through the above solution, specifically transmits the downlink information via the network device, enabling the terminal device to determine the TCI state(s) of the PUSCH based on the downlink information. This provides a method for determining the TCI state(s) of the PUSCH, applicable to both spatial division multiplexing and single frequency network transmission. This method improves the applicability of beam measurement reporting in scenarios with simultaneous uplink transmission on multiple panels.

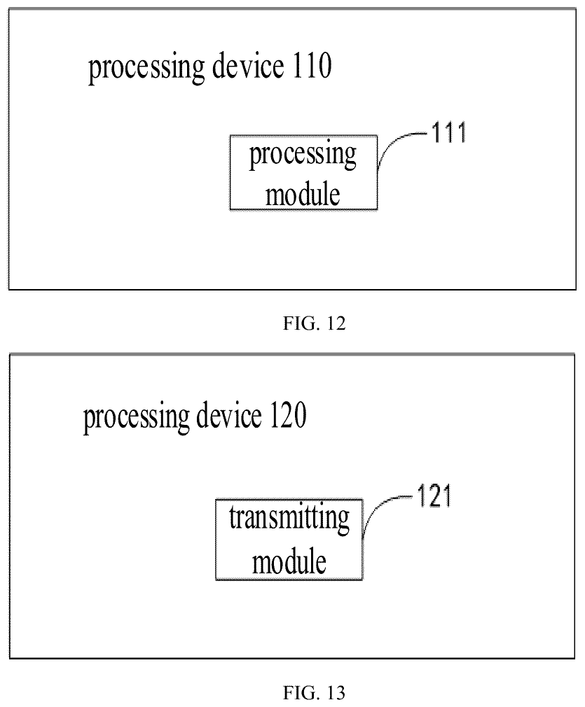

Please refer to FIG. 12, FIG. 12 is a schematic structural diagram of a processing device according to an embodiment of the present application. This device may be installed in or be the terminal device in the above-described method embodiment. The processing device shown in FIG. 12 can be used to perform some or all of the functions of the method embodiment described in the above-described embodiment. As shown in FIG. 12, the processing device 110 includes a processing module 111.

The processing module 111 is configured to determine the TCI state(s) of the PUSCH based on the downlink information.

Optionally, the downlink information includes RRC signaling and/or DCI.

Optionally, the DCI is generated or determined by the network device based on the beam measurement information reported by the terminal device.

Optionally, the beam measurement information includes at least one group of beam measurement results.

Optionally, the beam measurement results include first content and/or second content.

Optionally, the first content includes at least one of the following: at least one CRI, at least one SSBRI, at least one L1-RSRP, and at least one L1-SINR.

Optionally, the second content includes at least one of the following: at least one terminal device capability value, at least one terminal device capability value group, at least one same panel determination value, at least one panel offset value, and at least one panel index value.

Optionally, the device further includes at least one of the following:
the terminal device capability value indicates at least one of the maximum number of supported SRS antenna ports, the maximum number of supported layers, the maximum number of supported antennas, and the maximum number of supported antenna ports;
the terminal device capability value group includes a first terminal device capability value and at least one second terminal device capability value;
the same panel determination value indicates whether the channel measurement resources are received by the same panel;
the panel offset value indicates the offset of the panel index value corresponding to the panel receiving the channel measurement resources;
the terminal device capability value groups are different;
the terminal device capability values are the same; and
the terminal device capability values are different.

Optionally, the first terminal device capability value indicates the maximum number of supported SRS antenna ports.

Optionally, the second terminal device capability value indicates at least one of the maximum number of supported layers, the maximum number of supported antennas, and the maximum number of supported antenna ports.

Optionally, the device further includes:
determining the transmission mode of the PUSCH based on the RRC signaling and/or DCI.

Optionally, the RRC signaling includes at least one of a PUSCH transmission scheme parameter, a PUSCH spatial division multiplexing single frequency network scheme parameter, a PUSCH single frequency network scheme parameter, and a PUSCH allocation list parameter.

Optionally, determining the transmission mode of the PUSCH based on the RRC signaling and/or DCI includes at least one of the following:
if the RRC signaling and/or DCI satisfies the first condition, the PUSCH transmission uses the spatial division multiplexing scheme;
if the RRC signaling and/or DCI satisfies the second condition, the PUSCH transmission uses the single frequency network scheme; or
if the RRC signaling satisfies the third condition, the PUSCH transmission uses the time division multiplexing scheme.

Optionally, satisfying the first condition includes at least one of the following:
the PUSCH transmission scheme parameter is set to the spatial division multiplexing;
the PUSCH spatial division multiplexing single frequency network scheme parameter is set to the spatial division multiplexing;
the PUSCH allocation list parameter is not configured with the repetition number parameter, and the PUSCH single frequency network scheme parameter is not configured. The DCI indicates two TCI states, and the antenna port field in the DCI indicates that the DMRS ports are included in two code division multiplexing groups.

The PUSCH allocation list parameter is not configured with the repetition number parameter, the DCI indicates two TCI states, and the antenna port field in the DCI indicates that the DMRS ports are included in two code division multiplexing groups.

Optionally, satisfying the second condition includes at least one of the following:
the PUSCH transmission scheme parameter is set to the single frequency network;
The PUSCH spatial division multiplexing single frequency network scheme parameter is set to the single frequency network;
the PUSCH single frequency network scheme parameter is set to enabled;
the PUSCH allocation list parameter is not configured with the repetition number parameter, the DCI indicates two TCI states, and the antenna port field in the DCI indicates that the DMRS ports are included in one code division multiplexing group.

Optionally, satisfying the third condition includes the PUSCH transmission scheme parameter being set to the time division multiplexing.

Optionally, determining the TCI state(s) of the PUSCH based on the downlink information includes:
providing the reference signal(s) for the corresponding PUSCH based on the TCI state(s) indicated by the value of the SRS resource set indicator field in the DCI; and/or providing the reference signal(s) for the corresponding PUSCH based on the TCI state(s) indicated by the value of the TCI state indicator parameter in the RRC signaling; and
determining the uplink transmission spatial filter based on the reference signal.

Optionally, providing the reference signal for the corresponding PUSCH based on the TCI state indicated by the value of the SRS resource set indicator field in the DCI includes at least one of the following:
the value of SRS resource set indicator field is a first value or a second value, the first TCI state provides the reference signal for the PUSCH associated with the terminal device capability value corresponding to the first TCI state, and the second TCI state provides the reference signal for the PUSCH associated with the terminal device capability value corresponding to the second TCI state;
the value of SRS resource set indicator field is a first value, the first TCI state provides the reference signal for the PUSCH associated with the first terminal device capability value, and the second TCI state provides the reference signal for the PUSCH associated with the second terminal device capability value;
the value of SRS resource set indicator field is a second value, the first TCI state provides the reference signal for the PUSCH associated with the second terminal device capability value, and the second TCI state provides the reference signal for the PUSCH associated with the first terminal device capability value;
the value of SRS resource set indicator field is a first value, the first TCI state provides the reference signal for the PUSCH associated with the first panel index value, and the second TCI state provides the reference signal for the PUSCH associated with the second panel index value;
the value of SRS resource set indicator field is a second value, the first TCI state provides the reference signal for the PUSCH associated with the second panel index value, and the second TCI state provides the reference signal for the PUSCH associated with the first panel index value;
if simultaneous transmission of multiple-panel PUSCH uses the spatial division multiplexing scheme, and the value of SRS resource set indicator field is the first value or the second value, the first TCI state provides the reference signal for the first PUSCH, and the second TCI state provides the reference signal for the second PUSCH;
if simultaneous transmission of multiple-panel PUSCH uses the single frequency network scheme, and the value of SRS resource set indicator field is the first value or the second value, the first and second TCI states provide the reference signal for the PUSCH.

Optionally, providing the reference signal(s) for the corresponding PUSCH based on TCI state(s) indicated by the value of the TCI state indicator parameter in the RRC signaling includes:
if simultaneous transmission of multiple-panel PUSCH uses the spatial division multiplexing scheme, and the TCI state indicator parameter indicates that the TCI states used for transmission of the PUSCH are the first TCI state and the second TCI state, the first TCI state provide the reference signal for the first PUSCH, and the second TCI state provides the reference signal for the second PUSCH; and/or
if simultaneous transmission of multiple-panel PUSCH uses the single frequency network scheme, and the TCI state indicator parameter indicates that the TCI states used for the PUSCH transmission are the first and second TCI states, the first and second TCI states provide reference signals for the PUSCH.

The processing device provided in this embodiment of the present application can implement the technical solutions described in the above method embodiments. The implementation principles and beneficial effects are similar and are not further elaborated here.

Please refer to FIG. 13, FIG. 13 is a schematic structural diagram of a processing device according to an embodiment of the present application. This device may be installed in or be the network device in the aforementioned method embodiment. As shown in FIG. 13, the processing device 120 includes a transmitting module 121.

The transmitting module 121 is configured to transmit the downlink information, enabling a terminal device to determine the TCI state(s) of a PUSCH based on the downlink information.

Optionally, the device further includes at least one of the following:
generating or determining the DCI based on the beam measurement information;
adding at least one of a PUSCH transmission scheme parameter, a PUSCH spatial division multiplexing single frequency network scheme parameter, and a PUSCH single frequency network scheme parameter in the RRC signaling; and
transmitting the RRC signaling, so that the terminal device determines the transmission mode of the PUSCH based on the RRC signaling and/or the DCI.

The processing device provided in the embodiments of the present application can implement the technical solutions described in the aforementioned method embodiments. The implementation principles and beneficial effects are similar and will not be further elaborated here.

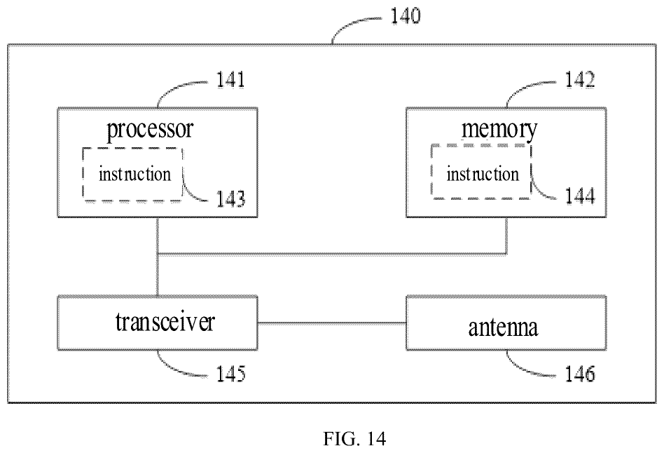

Referring to FIG. 14, FIG. 14 is a schematic structural diagram of a communication device according to an embodiment of the present application. As shown in FIG. 14, the communication device 140 described in this embodiment can be the terminal device (or component applicable to a terminal device) or network device (or component applicable to a network device) mentioned in the aforementioned method embodiments. Communication device 140 can be used to implement the method corresponding to the terminal device or network device described in the above method embodiment. For details, please refer to the description of the above method embodiment.

The communication device 140 may include one or more processors 141, which may also be referred to as processing units, and may perform certain control or processing functions. The processor 141 may be a general-purpose processor or a dedicated processor. For example, it may be a baseband processor or a central processing unit. The baseband processor may be used to process communication protocols and communication data, while the central processing unit may be used to control the communication device, execute software programs, and process software program data.

Optionally, the processor 141 may also store instructions 143 or data (e.g., intermediate data). Optionally, the instructions 143 may be executed by the processor 141 to enable the communication device 140 to perform the method corresponding to the terminal device or network device described in the above method embodiment.

Optionally, the communication device 140 may include a circuit that can implement the functions of transmitting, receiving, or communicating in the above method embodiments.

Optionally, the communication device 140 may include one or more memories 142, on which an instruction 144 can be stored. The instruction may be executed by the processor 141, causing the communication device 140 to perform the methods described in the above method embodiments.

Optionally, the memories 142 may also store data. The processor 141 and memories 142 may be provided separately or integrated together.

Optionally, the communication device 140 may further include a transceiver 145 and/or an antenna 146. The processor 141 may be referred to as a processing unit, and controls the communication device 140 (terminal device, core network device, or radio access network device). The transceiver 145 may be referred to as a transceiver unit, transceiver, transceiver circuit, or transceiver, and is configured to implement the transceiver functions of the communication device 140.

Optionally, if the communication device 140 is configured to implement operations corresponding to the terminal device described in the aforementioned embodiments, for example, the transceiver 145 may receive the downlink information, and the processor 141 may determine the TCI state of the PUSCH based on the downlink information.

Optionally, the specific implementation of the processor 141 and the transceiver 145 can be found in the relevant descriptions of the above embodiments and will not be repeated here.

Optionally, if the communication device 140 is configured to implement operations corresponding to the network devices described in the above embodiments, for example, the transceiver 145 may transmit the downlink information, allowing the terminal device to determine the TCI state of the PUSCH based on the downlink information.

Optionally, the specific implementation of the processor 141 and the transceiver 145 can refer to the relevant description of the above embodiments, and will not be repeated here.

The processor 141 and transceiver 145 described in the present application may be implemented in an integrated circuit (IC), an analog integrated circuit, a radio frequency integrated circuit (RFIC), a mixed-signal integrated circuit, an application specific integrated circuit (ASIC), a printed circuit board (PCB), an electronic device, etc. The processor 141 and the transceiver 145 may also be manufactured using various integrated circuit process technologies, such as complementary metal oxide semiconductor (CMOS), N metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

In the present application, the communication device may be a terminal device (such as a mobile phone) or a network device (such as a base station), depending on the context. In addition, the terminal device can be implemented in various forms. For example, the terminal devices described in the present application may include mobile terminals such as mobile phones, tablet computers, laptop computers, personal digital assistants (PDAs), portable media players (PMPs), navigation devices, wearable devices, smart bracelets, pedometers, etc., as well as fixed terminal devices such as digital TVs and desktop computers.

Although the communication device is described above by taking a terminal device or a network device as an example, the scope of the communication device described in the present application is not limited to the above-mentioned terminal device or network device, and the structure of the communication device may not be limited to FIG. 14. The communication device may be an independent device or may be part of a larger device.

The present application also provides a communication system, including: the terminal device as described in any of the above method embodiments; and the network device as described in any of the above method embodiments.

An embodiment of the present application also provides a communications device, including a memory and a processor. A processing program is stored on the memory, and when the processing program is executed by the processor, the steps of the processing method described in any of the above-mentioned embodiments are implemented.

The communications device herein may be a terminal device (e.g., a mobile phone) or a network device (e.g., a base station), depending on the context.

An embodiment of the present application also provides a storage medium, on which the processing program is stored. When the processing program is executed by the processor, the steps of the processing method described in any of the above-mentioned embodiments are implemented.

In the embodiments of the communication device and the storage medium provided in the embodiments of the present application, all technical features of any of the above-mentioned processing method embodiments may be included. The expanded and explained contents of the specification are basically the same as those of the embodiments of the above-mentioned methods and will not be repeated here.

The present application also provides a computer program product, which includes computer program code. When the computer program code is executed on a computer, the computer executes the methods described in the various possible embodiments.

The present application also provides a chip, including a memory and a processor. The memory is configured to store a computer program, and the processor is configured to call and execute the computer program from the memory, thereby causing a device equipped with the chip to perform the methods described in the various possible embodiments.

It can be understood that the above scenarios are merely examples and do not limit the application scenarios of the technical solutions provided in the embodiments of the present application. The technical solutions of the present application can also be applied to other scenarios. For example, those skilled in the art will appreciate that with the evolution of system architecture and the emergence of new business scenarios, the technical solutions provided in the embodiments of the present application will also be applicable to similar technical problems.

The above serial numbers of the embodiments of the present application are only for description and do not represent the advantages or disadvantages of the embodiments.

The steps in the methods according to the embodiments of the present application can be sequence adjusted, combined, and deleted according to actual needs.

The unit in the device according to the embodiments of the present application can be merged, divided, and deleted according to actual needs.

In the present application, the same or similar terms, concepts, technical solutions and/or application scenario descriptions are generally only described in detail the first time they appear. When they appear again, for the sake of simplicity, they are generally not described again. When understanding the technical solutions and other content of the present application, for the same or similar term concepts, technical solutions and/or application scenario descriptions that are not described in detail later, refer to the relevant previous detailed descriptions.

In the present application, the descriptions of each embodiment have their own emphases, and for parts that are not detailed or recorded in a certain embodiment, refer to the relevant descriptions of other embodiments.

The technical features of the present application can be combined in any way. To simplify the description, not all possible combinations of the technical features in the above embodiments are described. However, as long as there is no contradiction in the combination of these technical features, they should be considered to be within the scope of the present application.

Through the description of the above embodiments, those skilled in the art can clearly understand that the methods of the above embodiments can be implemented by means of software plus a necessary general-purpose hardware platform, and of course also by hardware, but in many cases the former is better implementation. Based on this understanding, the essence of the technical solution of the present application or the part that contributes to the prior art can be embodied in the form of software products, the computer software product is stored in one of the above storage medium (such as ROM/RAM, magnetic disk, optical disk), including several instructions to make a terminal device (which may be a mobile phone, a computer, a server, a controlled terminal, or a network device, etc.) execute the method of each embodiment of the present application.

In the above embodiments, it may be implemented in whole or in part by software, hardware, firmware, or any combination thereof. When implemented using software, it may be implemented in whole or in part in the form of a computer program product. A computer program product includes one or more computer instructions. When computer program instructions are loaded and executed on a computer, processes or functions according to embodiments of the present application are generated in whole or in part. The computer may be a general purpose computer, a special purpose computer, a computer network, or other programmable device. Computer instructions may be stored in or transmitted from one computer-readable storage medium to another computer-readable storage medium, e.g., computer instructions may be transmitted from a website, computer, server or data center via a wired link (e.g. coaxial cable, optical fiber, digital subscriber line) or wireless (such as infrared, wireless, microwave, etc.) means to transmit to another website site, computer, server or data center. Computer-readable storage medium can be any available medium that can be accessed by a computer or a data storage device such as a server, data center, or other integrated medium that contains one or more available medium. Available medium may be magnetic medium (e.g., floppy disk, storage disk, magnetic tape), optical medium (e.g., DVD), or semiconductor medium (e.g., Solid State Disk (SSD)), etc.

The above are only some embodiments of the present application, and are not therefore limiting the scope of the present application. Any equivalent structure or equivalent process transformation made by using the contents of the specification and drawings of the present application, or directly or indirectly used in other related technical fields, is also included in the scope of the present application.

What is claimed is:

1. A processing method, comprising:
determining a transmission configuration indicator (TCI) state of a physical uplink shared channel (PUSCH) based on downlink information.

2. The method of claim 1, wherein the downlink information comprises radio resource control (RRC) signaling and/or downlink control information (DCI).

3. The method of claim 2, wherein the DCI is generated or determined by a network device based on beam measurement information reported by a terminal device.

4. The method of claim 3, wherein the beam measurement information comprises at least one group of beam measurement results; and/or the beam measurement results comprise first content and/or second content.

5. The method of claim 4, wherein the first content comprises at least one of the following: at least one channel state information reference signal resource indicator (CRI), at least one synchronization signal block resource indicator (SSBRI), at least one layer 1 (L1)-reference signal received power (L1-RSRP), and at least one L1-signal to interference plus noise ratio (L1-SINR); and/or
the second content comprises at least one of the following: at least one terminal device capability value, at least one terminal device capability value group, at least one same panel determination value, at least one panel offset value, and at least one panel index value.

6. The method of claim 5, further comprising at least one of the following:
the terminal device capability value indicating at least one of a maximum number of supported sounding reference signal (SRS) antenna ports, a maximum number of supported layers, a maximum number of supported antennas, and a maximum number of supported antenna ports;
the terminal device capability value group comprising a first terminal device capability value and at least one second terminal device capability value;
the same panel determination value indicating whether channel measurement resources are received by a same panel;
the panel offset value indicating an offset of a panel index value corresponding to a panel receiving the channel measurement resources;
the terminal device capability value groups being different;
the terminal device capability values being the same;
the terminal device capability values being different;
one group of beam measurement results comprising two channel state information reference signal resource indicators and/or two synchronization signal block resource indicators;
the beam measurement information being reported using the group-based beam reporting method; and
at least one channel state information reference signal resource indicator and/or at least one synchronization signal block resource indicator being applied to uplink simultaneous transmission.

7. The method of claim 6, wherein:
the first terminal device capability value indicates a maximum number of supported SRS antenna ports; and/or
the second terminal device capability value indicates at least one of a maximum number of supported layers, a maximum number of supported antennas, and a maximum number of supported antenna ports; and/or
the group-based beam reporting parameter is comprised in a channel state information reporting configuration information element.

8. The method of claim 2, further comprising:
determining a transmission mode of the PUSCH based on the RRC signaling and/or the DCI.

9. The method of claim 8, wherein:
the RRC signaling comprises at least one of a PUSCH transmission scheme parameter, a PUSCH spatial division multiplexing single frequency network scheme parameter, a PUSCH single frequency network scheme parameter, and a PUSCH allocation list parameter; and/or
determining the transmission mode of the PUSCH based on the RRC signaling and/or the DCI comprises at least one of the following:
in response to that the RRC signaling and/or the DCI satisfies a first condition, the transmission mode of the PUSCH being spatial division multiplexing (SDM);
in response to that the RRC signaling and/or the DCI satisfies a second condition, the transmission mode of the PUSCH being single frequency network (SFN); or
in response to that the RRC signaling satisfies a third condition, the transmission mode of the PUSCH being time division multiplexing (TDM).

10. The method of claim 9, further comprising at least one of the following:
satisfying the first condition comprising at least one of the following:
the PUSCH transmission scheme parameter being set to spatial division multiplexing;
the PUSCH spatial division multiplexing single frequency network scheme parameter being set to spatial division multiplexing;
the PUSCH allocation list parameter being not configured with a repetition number parameter, and the PUSCH single frequency network scheme parameter being not configured;
the DCI indicating two TCI states; and an antenna port field in the DCI indicating that DMRS ports are comprised in two code division multiplexing groups;
the PUSCH allocation list parameter being not configured with a repetition number parameter, the DCI indicating two TCI states, and the antenna port field in the DCI indicating that the DMRS ports are comprised in two code division multiplexing groups;
the PUSCH configuration information element comprising PUSCH spatial multiplexing scheme parameter;
satisfying the second condition comprising at least one of the following:
the PUSCH transmission scheme parameter being set to single frequency network;
the PUSCH spatial division multiplexing single frequency network scheme parameter being set to single frequency network;
the PUSCH single frequency network scheme parameter being set to enabled;
the PUSCH allocation list parameter being not configured with a repetition number parameter, the DCI indicating two TCI states, and the antenna port field in the DCI indicating that the DMRS ports are comprised in a code division multiplexing group;
satisfying the third condition comprising:
the PUSCH transmission scheme parameter being set to time division multiplexing.

11. The method of claim 2, wherein the step of determining the TCI state of the PUSCH based on the downlink information comprises:
providing a reference signal for a corresponding PUSCH based on the TCI state indicated by a value of the SRS resource set indicator field in the DCI; and/or providing the reference signal for a corresponding PUSCH based on the TCI state indicated by a value of the TCI state indicator parameter in the RRC signaling; and
determining an uplink transmission spatial filter based on the reference signal.

12. The method of claim 11, wherein
providing the reference signal for the corresponding PUSCH based on the TCI state indicated by the value of the SRS resource set indicator field in the DCI comprises at least one of the following:
the value of SRS resource set indicator field being a first value or a second value, a first TCI state providing a reference signal for a PUSCH associated with a terminal device capability value corresponding to the first TCI state, and the second TCI state providing a reference signal for a PUSCH associated with a terminal device capability value corresponding to the second TCI state;
the value of SRS resource set indicator field being a first value, the first TCI state providing a reference signal for a PUSCH associated with a first terminal device capability value, and the second TCI state providing the reference signal for a PUSCH associated with a second terminal device capability value;
the value of SRS resource set indicator field being a second value, the first TCI state providing a reference signal for a PUSCH associated with a second terminal device capability value, and the second TCI state providing a reference signal for a PUSCH associated with a first terminal device capability value;
the value of SRS resource set indicator field being a first value, the first TCI state providing a reference signal for a PUSCH associated with a first panel index value, and the second TCI state providing a reference signal for a PUSCH associated with the second panel index value;
the value of SRS resource set indicator field being a second value, the first TCI state providing a reference signal for a PUSCH associated with a second panel index value, and the second TCI state providing a reference signal for a PUSCH associated with a first panel index value;
in response to that simultaneous transmission of multiple-panel PUSCH uses the spatial division multiplexing scheme, and the value of SRS resource set indicator field is the first value or the second value, the first TCI state providing a reference signal for a first PUSCH, and the second TCI state providing a reference signal for a second PUSCH; or
in response to that simultaneous transmission of multiple-panel PUSCH uses the single frequency network scheme, and the value of SRS resource set indicator field is the first value or the second value, the first TCI state and the second TCI state providing reference signals for the PUSCH; and/or
providing the reference signal for the corresponding PUSCH based on the TCI state indicated by the value of the TCI state indicator parameter in the RRC signaling comprises:
in response to that simultaneous transmission of multiple-panel PUSCH uses the spatial division multiplexing scheme, and the TCI state indicator parameter indicates that TCI states used for transmission of the PUSCH are the first TCI state and the second TCI state, the first TCI state providing a reference signal for the first PUSCH, and the second TCI state providing a reference signal for the second PUSCH; and/or,
in response to that simultaneous transmission of multiple-panel PUSCH uses the single frequency network scheme, and the TCI state indicator parameter indicates that TCI states used for transmission of the PUSCH are the first TCI state and the second TCI state, the first TCI state and the second TCI state providing reference signals for the PUSCH.

13. The method of claim 2, wherein the determining the TCI state of the PUSCH based on the downlink information comprises:
indicating the TCI state of the PUSCH based on a value of a SRS resource set indicator field in the DCI.

14. The method of claim 13, further comprising at least one of the following:
the TCI state being an uplink TCI state or a joint TCI state;
the TCI state comprising a first uplink TCI state or the joint TCI state; and
the TCI state comprising a second uplink TCI state or the joint TCI state.

15. The method of claim 14, further comprising at least one of the following:
the first uplink TCI state or the joint TCI state being associated with a first group of antenna ports; and
the second uplink TCI state or the joint TCI state being associated with a second group of antenna ports.

16. The method of claim 15, further comprising at least one of the following:
the PUSCH using the spatial multiplexing scheme; and
the first group of antenna ports and/or the second group of antenna ports being antenna ports of the PUSCH.

17. A processing method, comprising:
transmitting downlink information, so that a terminal device determines a transmission configuration indicator (TCI) state of a physical uplink shared channel (PUSCH) based on downlink information.

18. The method of claim 17, further comprising at least one of the following:
generating or determining downlink control information (DCI) based on beam measurement information;
adding at least one of a PUSCH transmission scheme parameter, a PUSCH spatial division multiplexing single frequency network scheme parameter, and a PUSCH single frequency network scheme parameter in radio resource control (RRC) signaling;
adding a group-based beam reporting parameter in the channel state information reporting configuration information element; and
transmitting the RRC signaling, so that the terminal device determines a transmission mode of the PUSCH based on the RRC signaling and/or the DCI.

19. A communication device, comprising a memory, a processor and a processing program stored in the memory and executable on the processor, wherein when the processing program is executed by the processor, the processing method of claim 1 is implemented.

20. A non-transitory computer-readable storage medium, wherein a computer program is stored on the non-transitory computer-readable storage medium, and when the computer program is executed by a processor, the processing method of claim 1 is implemented.
